(19) United States
(12) Patent Application Publication
(10) Pub. No.: US 2024/0274021 A1
(43) Pub. Date: Aug. 15, 2024

(54) SYSTEMS AND METHODS OF FACILITATING USERS TO LEARN TRAINING PETS

(71) Applicant: Cristian Diaconu, Alexandria, VA (US)

(72) Inventor: Cristian Diaconu, Alexandria, VA (US)

(21) Appl. No.: 18/109,862

(22) Filed: Feb. 15, 2023

(51) Int. Cl. G09B 5/02

(52) U.S. Cl. CPC G09B 5/02

(57) ABSTRACT

Disclosed herein is a method of facilitating users to learn training pets. The method may include receiving a request from a user to learn training a real pet from a user device. Further, the method may include retrieving a training data associated with the training of the pets based on the request. Additionally, the method may include generating a first session data of a first session of the one or more sessions for the user to learn the training of the real pet with a first pet behavior of the one or more pet behaviors based on the request and the training data. Also, the method may include transmitting the first session data to the user device and receiving one or more first user action data associated with a first user action and a first user action instance of the first user action of the user from the user device.

### FIELD OF DISCLOSURE

The present disclosure generally relates to input arrangements or combined input and output arrangements for interaction between user and computer. More specifically, the present disclosure relates to systems and methods of facilitating users to learn training pets.

### BACKGROUND

The field relating to input arrangements or combined input and output arrangements for interaction between user and computer is technologically important to several industries, business organizations, and/or individuals.

Existing techniques of facilitating users to learn training pets are deficient in several ways. For instance, current technologies do not allow a user to train a pet (such as a dog) based on providing positive reinforcements using virtual reality. Further, current technologies for training a pet do not assist a user in retaining and confidently applying the training information for training the pet. These current training technologies fail to deliver a correct training stimulus (with optimal frequency and magnitude) to the pet. Furthermore, current technologies for training pets are inherently inconsistent in delivering stimulus.

Therefore, there is a need for systems and methods of facilitating users to learn training pets that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating users to learn training pets. Also, the method may include receiving, using a communication device, a request from a user to learn training a real pet from a user device. Further, the method may include retrieving, using a storage device, a training data associated with the training of the pets based on the request. Furthermore, the training data includes one or more sessions for the user to learn the training of the pets with one or more pet behaviors. Additionally, the method may include generating, using a processing device, a first session data of a first session of the one or more sessions for the user to learn the training of the real pet with a first pet behavior of the one or more pet behaviors based on the request and the training data. Furthermore, the first session data includes a first virtual representation of one or more of a pet, one or more objects, and an assistant. Furthermore, the first session data further includes one or more first action data associated with a first action and a first action instance of the first action of the first virtual representation. Also, the method may include transmitting, using the communication device, the first session data to the user device. Furthermore, the user device includes an extended reality device. Furthermore, the extended reality device may be configured for rendering the first virtual representation and the first action of the first virtual representation at the first action instance. Further, the method may include receiving, using the communication device, one or more first user action data associated with a first user action and a first user action instance of the first user action of the user from the user device. Furthermore, the first user action at the first user action instance corresponds to the first action at the first action instance of the first virtual representation. Furthermore, the extended reality device may be configured for rendering a first interaction between the user and the first virtual representation based on the one or more first user action data and the one or more first action data.

The present disclosure provides a system for facilitating users to learn training pets. Accordingly, the system may include a storage device that may be configured for retrieving a training data associated with the training of the pets based on a request. Furthermore, the training data includes one or more sessions for the user to learn the training of the pets with one or more pet behaviors. Furthermore, the system may include a processing device communicatively coupled with the storage device. Furthermore, the processing device may be configured for generating a first session data of a first session of the one or more sessions for the user to learn the training of the real pet with a first pet behavior of the one or more pet behaviors based on the request and the training data. Furthermore, the first session data includes a first virtual representation of one or more of a pet, one or more objects, and an assistant. Furthermore, the first session data includes one or more first action data associated with a first action and a first action instance of the first action of the first virtual representation. Additionally, the system may include a communication device communicatively coupled with the processing device. Further, the communication device may be configured for receiving the request from a user to learn training a real pet from a user device. Also, the communication device may be configured for transmitting the first session data to the user device. Furthermore, the user device includes an extended reality device. Furthermore, the extended reality device may be configured for rendering the first virtual representation and the first action of the first virtual representation at the first action instance. Further, the communication device may be configured for receiving one or more first user action data associated with a first user action and a first user action instance of the first user action of the user from the user device. Furthermore, the first user action at the first user action instance corresponds to the first action at the first action instance of the first virtual representation. Furthermore, the extended reality device may be configured for rendering a first interaction between the user and the first virtual representation based on the one or more first user action data and the one or more first action data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating users to learn training pets, in accordance with some embodiments.

FIG. 3B illustrates a continuation of the flowchart of the method 300 of facilitating users to learn training pets, in accordance with some embodiments.

FIG. 4 illustrates a flowchart of a method 400 of facilitating users to learn training pets including determining at least one attribute of a real pet, in accordance with some embodiments.

FIG. 5 illustrates a flowchart of a method 500 of facilitating users to learn training pets including determining at least one attribute of a real pet, in accordance with some embodiments.

FIG. 6 illustrates a flowchart of a method 600 of facilitating users to learn training pets including determining at least one user attribute of a user, in accordance with some embodiments.

FIG. 7 illustrates a flowchart of a method 700 of facilitating users to learn training pets including determining at least one environment attribute of an environment, in accordance with some embodiments.

FIG. 8 illustrates a flowchart of a method 800 of facilitating users to learn training pets including terminating a first session, in accordance with some embodiments.

FIG. 9 illustrates a flowchart of a method 900 of facilitating users to learn training pets including receiving at least one second user action data associated with a second user action and a second user action instance of a user from a user device, in accordance with some embodiments.

FIG. 10 illustrates a block diagram of a system 1000 of facilitating users to learn training pets, in accordance with some embodiments.

FIG. 11 illustrates a block diagram of the system 1000 of facilitating users to learn training pets, in accordance with some embodiments.

FIG. 12 is a flow diagram of a method 1200 of facilitating users to learn training pets, in accordance with some embodiments.

FIG. 13 is a flow diagram of a method 1300 of facilitating users to learn training pets, in accordance with some embodiments.

FIG. 14 is a block diagram illustrating a plurality of user activities 1402-1406, a plurality of user tasks 1408-1420, and a plurality of user stories release 1422-1444 for facilitating users to learn training pets, in accordance with some embodiments.

FIG. 15 is a flow diagram of a method 1500 of facilitating users to learn training pets, in accordance with some embodiments.

FIG. 16 is a flow diagram of a method 1600 of facilitating users to learn training pets, in accordance with some embodiments

FIG. 17 is a continuation of a flow diagram of the method 1600 of facilitating users to learn training pets, in accordance with some embodiments.

FIG. 18 is a flow diagram of a method 1800 of facilitating users to learn training pets, in accordance with some embodiments.

FIG. 19 is a flow diagram of a method 1900 of facilitating users to learn training pets, in accordance with some embodiments.

FIG. 20 is a screenshot of a user interface 2000 of a software application associated with the system of facilitating users to learn training pets, in accordance with some embodiments.

FIG. 21 is a screenshot of a user interface 2100 of the software application associated with the system of facilitating users to learn training pets, in accordance with some embodiments.

FIG. 22 is a screenshot of a user interface 2200 of the software application associated with the system of facilitating users to learn training pets, in accordance with some embodiments.

FIG. 23 is a screenshot of a user interface 2300 of the software application associated with the system of facilitating users to learn training pets, in accordance with some embodiments.

FIG. 24 is a screenshot of a user interface 2400 illustrating a virtual representation of a pet 2406 and an assistant 2404 in a virtual reality environment 2402, in accordance with some embodiments.

FIG. 25 is a screenshot of the user interface 2400 further illustrating a virtual representation of a user (2502 and 2602) holding a clicker 2504 in the virtual reality environment 2402, in accordance with some embodiments.

FIG. 26 is a screenshot of the user interface 2400 further illustrating a virtual representation of the user (2502 and 2602) holding a treat 2604 in the virtual reality environment 2402, in accordance with some embodiments.

FIG. 27 is a screenshot of the user interface 2400 further illustrating a virtual representation of the user (2502 and 2602) throwing the treat 2604 in a first direction in the virtual reality environment 2402, in accordance with some embodiments.

FIG. 28 is a screenshot of the user interface 2400 further illustrating a virtual representation of the pet 2406 moving toward the treat 2604 in the virtual reality environment 2402, in accordance with some embodiments.

FIG. 29 is a screenshot of the user interface 2400 further illustrating a virtual representation of the pet 2406 facing the user (2502 and 2602) due to an utterance from the user (2502 and 2602) in the virtual reality environment 2402, in accordance with some embodiments.

FIG. 30 is a screenshot of the user interface 2400 further illustrating a virtual representation of the user (2502 and 2602) clicking the clicker 2504 in the virtual reality environment 2402 after the utterance, in accordance with some embodiments.

FIG. 31 is a screenshot of the user interface 2400 further illustrating a virtual representation of the user (2502 and 2602) throwing the treat 2604 in a second direction opposite to the first direction in the virtual reality environment 2402, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### OVERVIEW

The present disclosure describes methods and systems of facilitating users to learn training pets. Further, the present disclosure describes a virtual reality dog training product. Further, the virtual reality dog training product is a software application executed on a computing device (headset). Further, the virtual reality dog training product may be focused on new puppy owners. Further, the virtual reality dog training product may be open for any dog owner. Further, the virtual reality dog training product may include a headset (Oculus Quest 2, Meta Quest Pro, Valve Index, Sony PlayStation VR, HTC Vice Pro 2, and HP Reverb G2) that renders extended reality content based on executing a software application. Further, the headset includes a communication interface, a processor, input devices (sensors, buttons, etc.), and output devices (displays, speakers, etc.). Further, the user may create an account using the headset and select a breed of dog the user wants to learn to train and after creating the account and selecting the breed of dog the user wants to work with, the user may be able to select a skill to learn for training the dog. Further, the user may be guided by a virtual assistant (assistant) every step of the way in learning the skill. Further, the learning of the skill includes learning coordination and timing associated with the training of the dog. After learning the skills in VR, the user may now apply those skills by working with their real puppy.

Further, compared to dog training solutions on different applications or by watching video tutorials on YouTube™, the VR dog training product helps its users retain up to 400% more information, and feel 40% more confident in applying that information through its structured workflow.

Further, the VR dog training product includes at most 37 training behaviors designed for puppies. Further, the user may learn to train the dog in one or more of the training behaviors using the VR dog training product.

Further, the present disclosure describes a software application executed on the headset facilitating a user to learn training pets. Further, the user may sign in to the software application. Further, the user may be presented with a virtual assistant (similar to Synthesia.io) besides a regular menu of the software application after signing in. Further, the virtual assistant may be artificial intelligence (AI) powered. Further, the virtual assistant may be integrated with a natural language processing tool (ChatGPT). Further, the software application may use a speech-to-text application programming interface (API) to get the information from the user and send the information to the ChatGPT. Further, the ChatGPT processes and responds to the information textually. Further, the response from the ChatGPT is sent to the virtual assistant. Further, the virtual assistant converts the response from text to speech and presents the response to the user.

Further, the virtual assistant may also be integrated with an artificial intelligence model. Further, the AI model may be trained using the information and responses to guide the user through the software application and suggest the skills that the user needs to work on. The AI model may also remember user history, preferences, etc. of the user and be able to provide a more personalized approach to the user. For example, the user logs in to the software application, and the virtual assistant tries to determine what the user wants to work on today. If the user wants his real dog to come when called, then the virtual assistant suggests some skills to work on within the software application and describes the importance of the skills to the user.

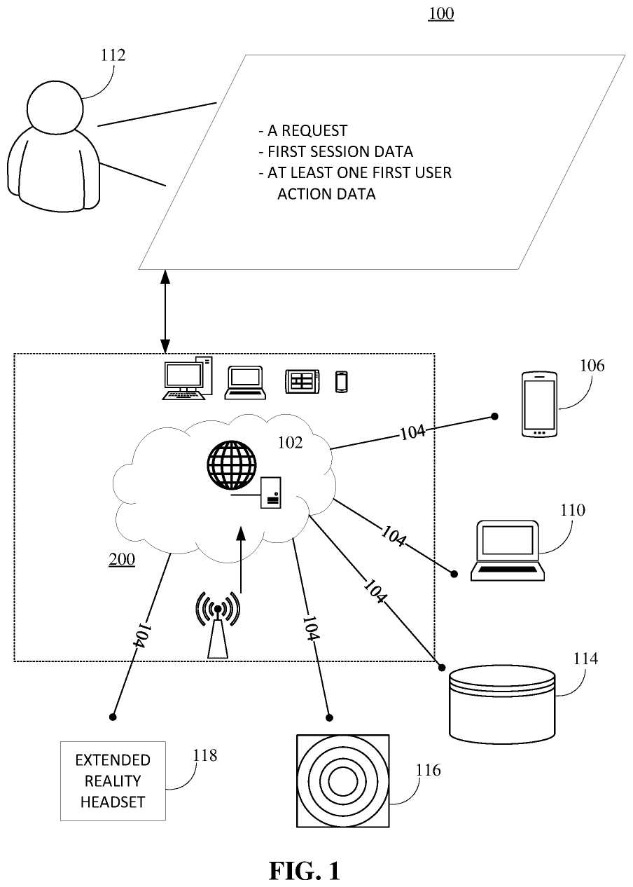

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, sensors 116, and an extended reality headset 118 (headset), over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

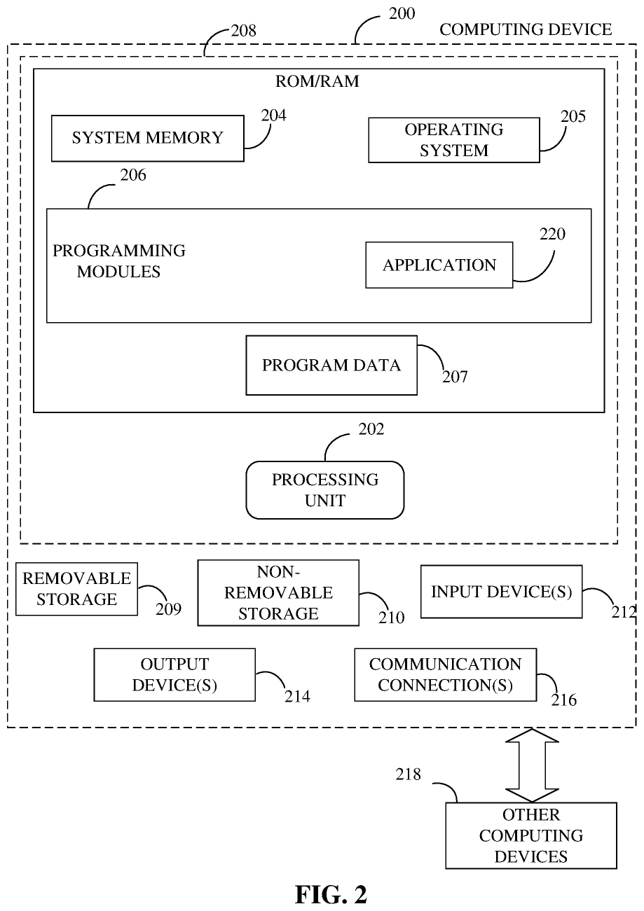

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

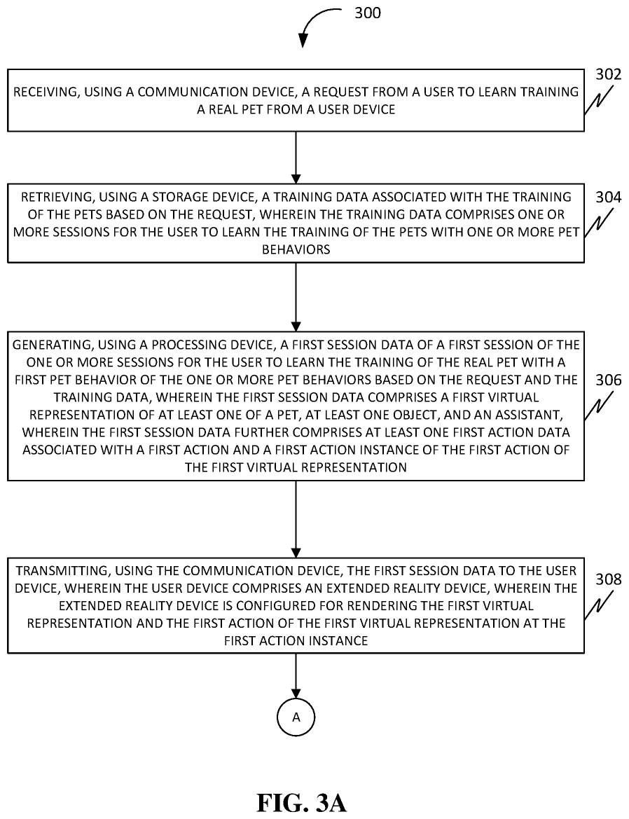

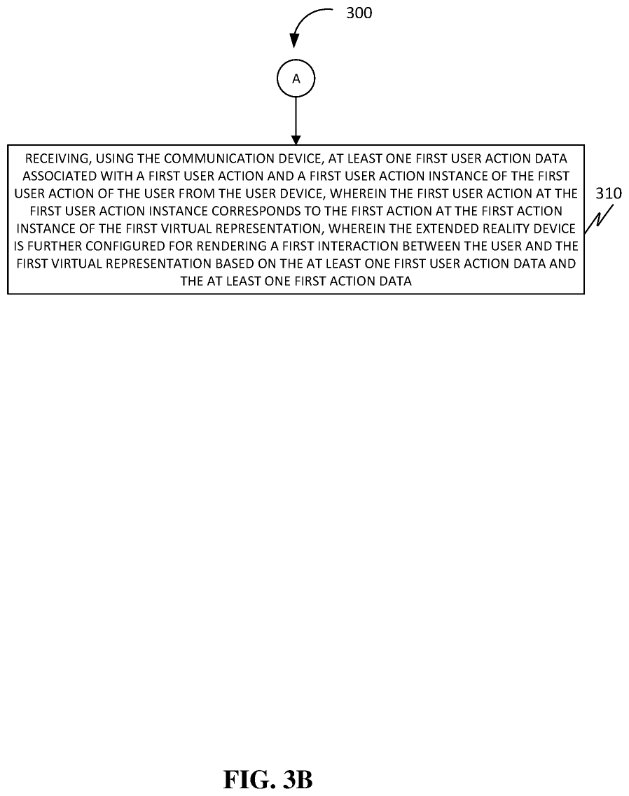

FIG. 3A and FIG. 3B illustrate a flowchart of a method 300 of facilitating users to learn training pets, in accordance with some embodiments.

Accordingly, the method 300 may include a step 302 of receiving, using a communication device 1006, a request from a user to learn training a real pet from a user device (such as a user device 1102). Further, the real pet may include a dog (puppy), a cat, a hamster, a hedgehog, a rabbit, etc. Furthermore, the method 300 may include a step 304 of retrieving, using a storage device 1002, a training data associated with the training of the pets based on the request. Additionally, the training data includes one or more sessions for the user to learn the training of the pets with one or more pet behaviors. Further, the one or more pet behaviors may include an exercise for the training of the pets. Further, the one or more sessions correspond to the one or more pet behaviors. Further, the one or more pet behaviors may include clicker training, crate training, name recognition training, nipping and play biting training, potty training, sitting training, etc. Moreover, the method 300 may include a step 306 of generating, using a processing device 1004, a first session data of a first session of the one or more sessions for the user to learn the training of the real pet with a first pet behavior of the one or more pet behaviors based on the request and the training data. Additionally, the first session data includes a first virtual representation of one or more of a pet, one or more objects, and an assistant. Further, the pet may include a dog, a cat, a hamster, a hedgehog, a rabbit, etc. Further, the one or more objects may include one or more training objects used by the user in an extended reality environment to learn the training of the pet. Further, the extended reality environment may include a virtual reality environment, an augmented reality environment, a mixed reality environment, etc. Further, the one or more training objects may include a leash, a clicker, a treat, a crate, etc. Further, the assistant may include an individual, AI-generated avatar, etc. Additionally, the first session data further includes one or more first action data associated with a first action and a first action instance of the first action of the first virtual representation. Further, the first action may include a movement, a gesture, an utterance, etc. of the pet in the extended reality environment, a presentation of information from the assistant, etc. Accordingly, the method 300 may include a step 308 of transmitting, using the communication device 1006, the first session data to the user device. Additionally, the user device includes an extended reality device. Further, the extended reality device may include a headset (extended reality headset). Additionally, the extended reality device may be configured for rendering the first virtual representation and the first action of the first virtual representation at the first action instance. Further, the extended reality device presents the first virtual representation and the first action of the first virtual representation at the first action instance in the extended reality environment based on the rendering. Furthermore, the method 300 may include a step 310 of receiving, using the communication device 1006, one or more first user action data associated with a first user action and a first user action instance of the first user action of the user from the user device. Additionally, the first user action at the first user action instance corresponds to the first action at the first action instance of the first virtual representation. Further, the first user action may include a movement and/or a gesture of the user in the extended reality environment, an utterance of the user in the extended reality environment, etc. Additionally, the extended reality device may be configured for rendering a first interaction between the user and the first virtual representation based on the one or more first user action data and the one or more first action data. Further, the first interaction may include a response associated with the first virtual representation in relation to the first user action and a response associated with the user in relation to the first action of the first virtual representation.

In some embodiments, the method 300 may further include initiating, using the processing device 1004, the first session of the one or more sessions based on the request. Also, the generating of the first session data of the first session may be further based on the initiating.

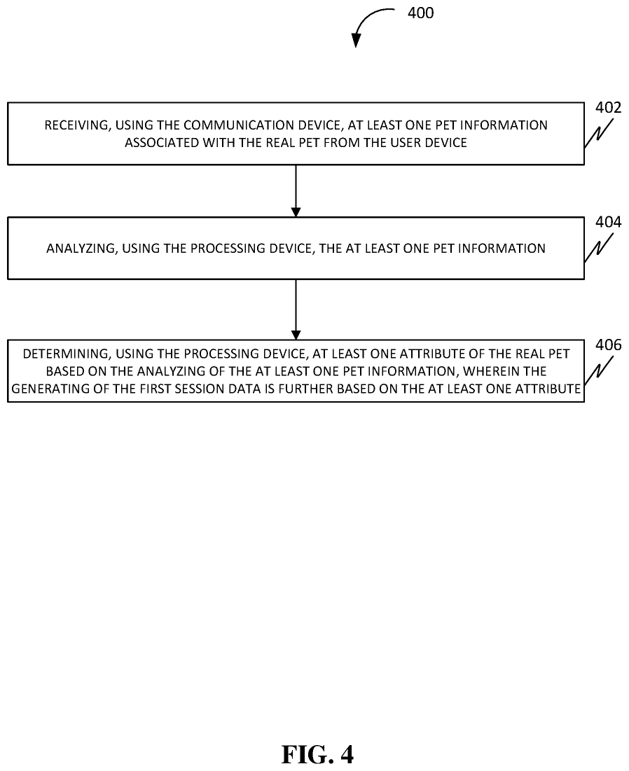

FIG. 4 illustrates a flowchart of a method 400 of facilitating users to learn training pets including determining at least one attribute of a real pet, in accordance with some embodiments.

Further, the method 400 may include a step 402 of receiving, using the communication device 1006, one or more pet information associated with the real pet from the user device. Further, the one or more pet information may include size information, weight information, breed information, coat information, behavior information, etc. Additionally, the method 400 may include a step 404 of analyzing, using the processing device 1004, the one or more pet information. Also, the method 400 further may include a step 406 of determining, using the processing device 1004, one or more attributes of the real pet based on the analyzing of the one or more pet information. Further, the one or more attributes may include shape, appearance, age, pliancy, obedience, etc. Accordingly, the generating of the first session data may be based on the one or more attributes. Further, the first virtual representation of the assistant may be associated with an instructional movement, an instructional gesture, and an instructional utterance that may be defined by the one or more attributes. Further, the first virtual representation of the pet may be associated with a visual characteristic (color, texture, etc.) that may be defined by the one or more attributes. Further, the first virtual representation of the one or more objects may include a physical characteristic (such as shape, size, etc.) that may be defined by the one or more attributes.

In some embodiments, the user device (client devices) further includes one or more imaging sensors (such as one or more imaging sensors 1106). Further, the one or more imaging sensors may include a visible light camera, an infrared camera, a hyperspectral camera, an X-ray camera, etc. Additionally, the one or more imaging sensors may be configured for generating the one or more pet information by imaging the real pet.

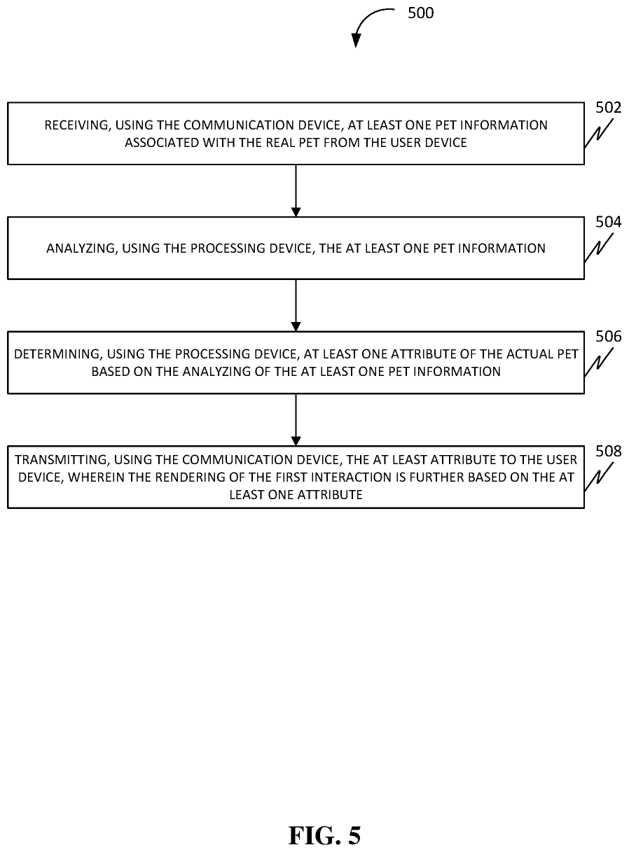

FIG. 5 illustrates a flowchart of a method 500 of facilitating users to learn training pets including determining at least one attribute of a real pet, in accordance with some embodiments.

Further, the method 500 may include a step 502 of receiving, using the communication device 1006, one or more pet information associated with the real pet from the user device. Further, the one or more pet information may include size information, weight information, breed information, coat information, behavior information, etc. Additionally, the method 500 may include a step 504 of analyzing, using the processing device 1004, the one or more pet information. Also, the method 500 further may include a step 506 of determining, using the processing device 1004, one or more attributes of the real pet based on the analyzing of the one or more pet information. Further, the one or more attributes may include age, pliancy, obedience, etc. Further, the method 500 may include a step 508 of transmitting, using the communication device 1006, the at least one attribute to the user device. Furthermore, the rendering of the first interaction may be based on the one or more attributes. Further, the one or more attributes may define the response of the first virtual representation of the pet for the first user action. Further, the response may include a reaction associated with the first virtual representation. Further, the response may include a movement, a gesture, and an utterance associated with the first virtual representation.

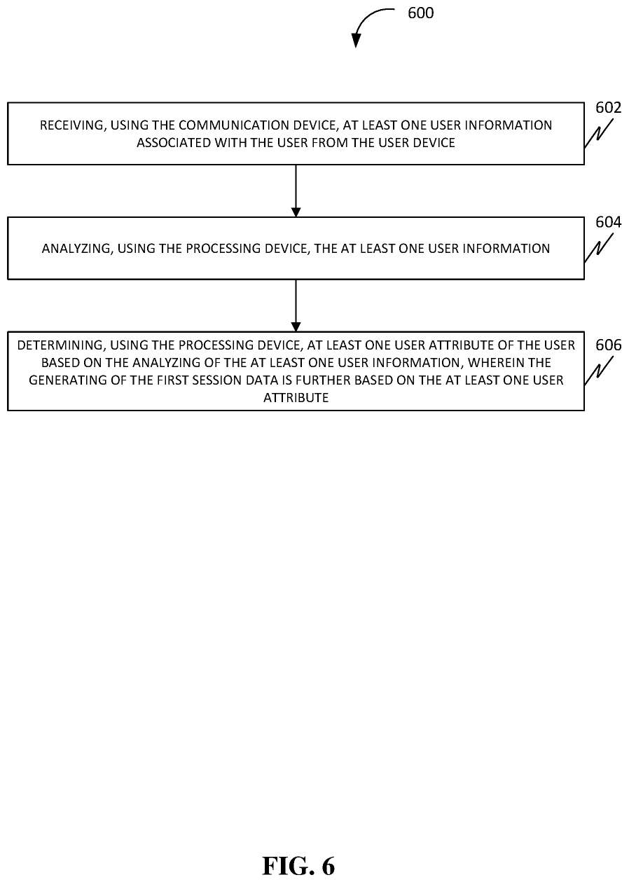

FIG. 6 illustrates a flowchart of a method 600 of facilitating users to learn training pets including determining at least one user attribute of a user, in accordance with some embodiments.

Accordingly, the method 600 further may include a step 602 of receiving, using the communication device 1006, one or more user information associated with the user from the user device. Further, the one or more user information may include pet preference information, pet ownership information, personal information, etc. Furthermore, the method 600 further may include a step 604 of analyzing, using the processing device 1004, the one or more user information. Moreover, the method 600 further may include a step 606 of determining, using the processing device 1004, one or more user attributes of the user based on the analyzing of the one or more user information. Further, the one or more user attributes may include a user's age, a preferred pet, a user's pet experience, etc. Also, the generating of the first session data may be further based on the one or more user attributes. Further, the first virtual representation of the pet may be associated with a visual characteristic (appearance, size, etc.) that may be defined by the one or more user attributes. Further, the first virtual representation of the assistant may be associated with an instructional movement, an instructional gesture, and an instructional utterance that may be defined by the one or more user attributes.

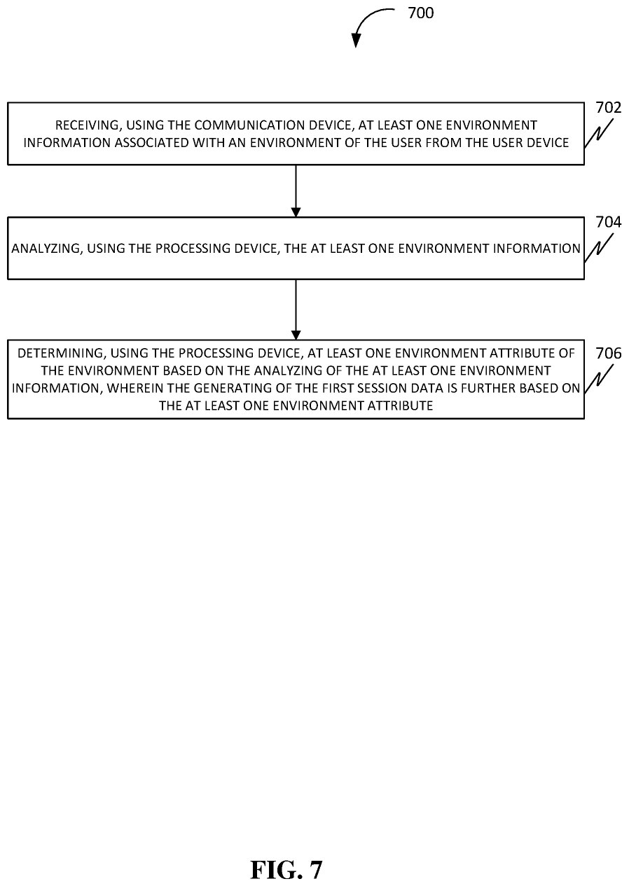

FIG. 7 illustrates a flowchart of a method 700 of facilitating users to learn training pets including determining at least one environment attribute of an environment, in accordance with some embodiments.

Additionally, the method 700 may include a step 702 of receiving, using the communication device 1006, one or more environment information associated with an environment of the user from the user device. Further, the one or more environment information may include background information associated with a background (background objects) associated with the first virtual representation, environment factor information, etc. Also, the method 700 may include a step 704 of analyzing, using the processing device 1004, the one or more environment information. Further, the method 700 may include a step 706 of determining, using the processing device 1004, one or more environment attributes of the environment based on the analyzing of the one or more environment information. Further, the one or more environment attributes may include the background, a lighting condition, a temperature condition, a precipitation condition, etc. Furthermore, the generating of the first session data may be based on the one or more environment attributes.

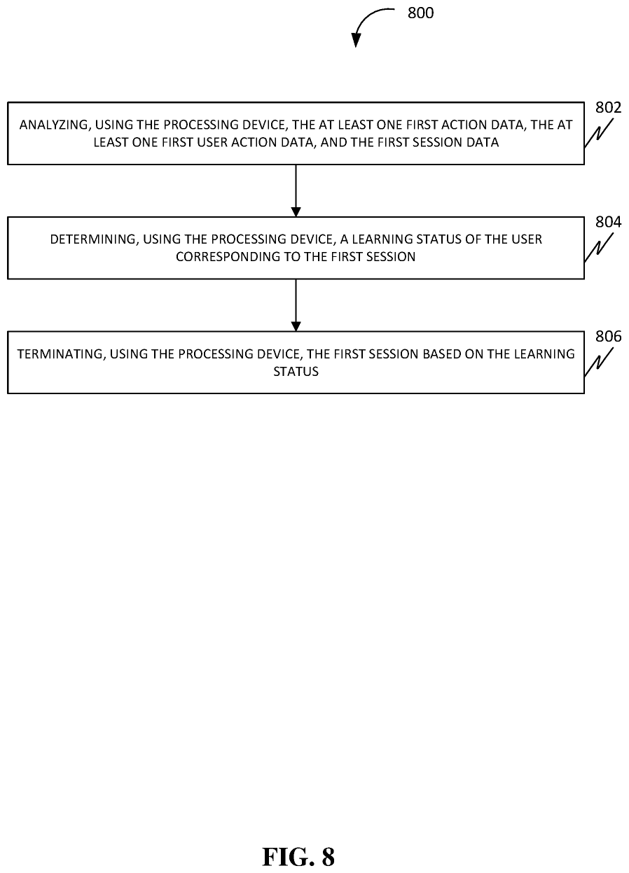

FIG. 8 illustrates a flowchart of a method 800 of facilitating users to learn training pets including terminating a first session, in accordance with some embodiments.

Additionally, the method 800 may include a step 802 of analyzing, using the processing device 1004, the one or more first action data, the one or more first user action data, and the first session data. Also, the method 800 further may include a step 804 of determining, using the processing device 1004, a learning status of the user corresponding to the first session. Further, the learning status of the user corresponds to a proficiency of the user in the training of the pets. Further, the method 800 may include a step 806 of terminating, using the processing device 1004, the first session based on the learning status.

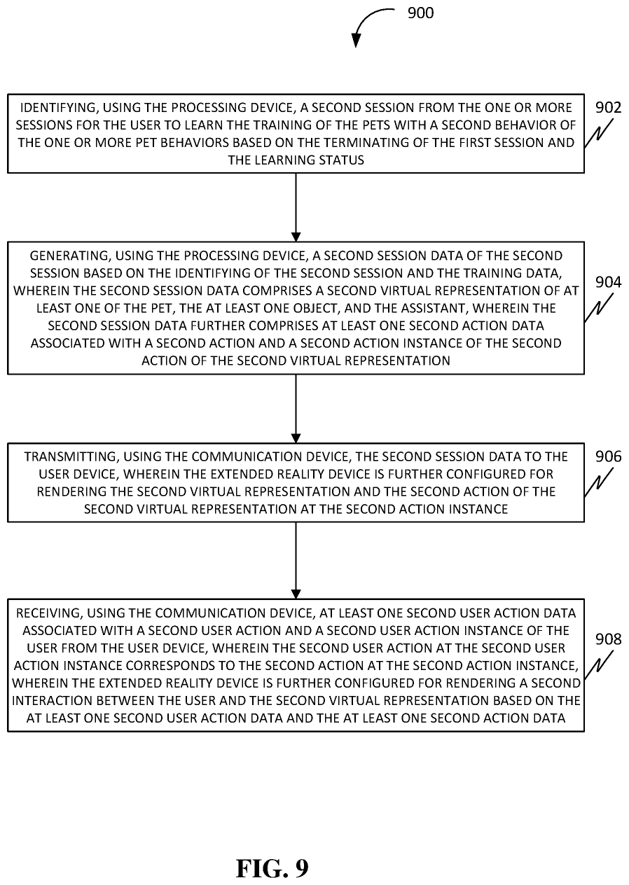

FIG. 9 illustrates a flowchart of a method 900 of facilitating users to learn training pets including receiving at least one second user action data associated with a second user action and a second user action instance of a user from a user device, in accordance with some embodiments.

Accordingly, the method 900 may include a step 902 of identifying, using the processing device 1004, a second session from the one or more sessions for the user to learn the training of the pets with a second behavior of the one or more pet behaviors based on the terminating of the first session and the learning status. Furthermore, the method 900 may include a step 904 of generating, using the processing device 1004, a second session data of the second session based on the identifying of the second session and the training data. Further, the second session data includes a second virtual representation of one or more of the pet, the one or more objects, and the assistant. Further, the second session data includes one or more second action data associated with a second action and a second action instance of the second action of the second virtual representation. Moreover, the method 900 may include a step 906 of transmitting, using the communication device 1006, the second session data to the user device. Further, the extended reality device may be configured for rendering the second virtual representation and the second action of the second virtual representation at the second action instance. Accordingly, the method 900 further may include a step 908 of receiving, using the communication device 1006, one or more second user action data associated with a second user action and a second user action instance of the user from the user device. Further, the second user action at the second user action instance corresponds to the second action at the second action instance. Further, the extended reality device may be configured for rendering a second interaction between the user and the second virtual representation based on the one or more second user action data and the one or more second action data.

In some embodiments, the first action includes a pet action associated with the pet, an object action associated with the one or more objects, and an assistant action associated with the assistant. Further, the pet action may include a movement, a gesture, an utterance, etc, of the pet. Further, the object action may include a movement, a position, a configuration, etc. of the one or more objects. Further, the assistant action may include a movement, a gesture, an utterance, etc, of the assistant. Moreover, the first action instance includes a pet action instance associated with the pet action, an object action instance associated with the object instance, and an assistant action instance associated with the assistant action. Moreover, the assistant action at the assistant action instance prompts the first user action at the first user action instance. Moreover, the first user action at the first user action instance corresponds to one or more of the pet action at the pet action instance and the object action at the object action instance. Moreover, the extended reality device may be further configured for rendering one or more prompts for the user based on the assistant action at the assistant action instance. Moreover, the user device includes at least one input device which may be configured for capturing the first user action at the first user action instance for the one or more prompts for generating the one or more first user action data. Further, the at least one input device may include sensors, buttons, etc.

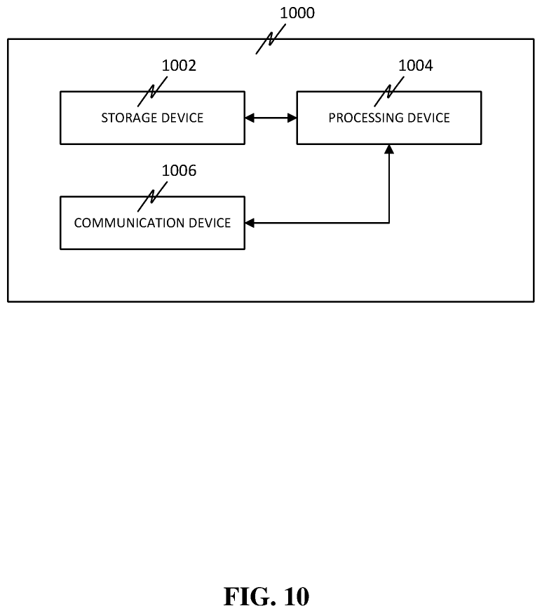

FIG. 10 illustrates a block diagram of a system 1000 of facilitating users to learn training pets, in accordance with some embodiments.

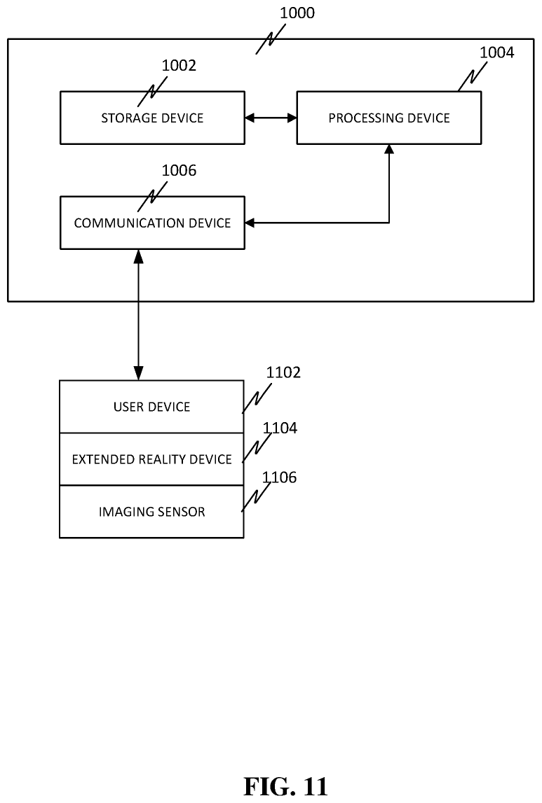

Accordingly, the system 1000 may include a storage device 1002 which may be configured for retrieving a training data associated with the training of the pets based on a request. Moreover, the training data includes one or more sessions for the user to learn the training of the pets with one or more pet behaviors. Moreover, the system 1000 may include a processing device 1004 communicatively coupled with the storage device 1002. Moreover, the processing device 1004 may be configured for generating a first session data of a first session of the one or more sessions for the user to learn the training of the real pet with a first pet behavior of the one or more pet behaviors based on the request and the training data. Moreover, the first session data includes a first virtual representation of one or more of a pet, one or more objects, and an assistant. Moreover, the first session data further includes one or more first action data associated with a first action and a first action instance of the first action of the first virtual representation. Also, the system 1000 may include a communication device 1006 communicatively coupled with the processing device 1004. Further, the communication device 1006 may be configured for receiving the request from a user to learn training a real pet from a user device 1102 (as shown in FIG. 11). Further, the communication device 1006 may be configured for transmitting the first session data to the user device 1102. Moreover, the user device 1102 includes an extended reality device 1104, as shown in FIG. 11. Further, the extended reality device 1104 may include a headset, a Head-mounted display (HMD) device, etc. Moreover, the extended reality device 1104 may be configured for rendering the first virtual representation and the first action of the first virtual representation at the first action instance. Additionally, the communication device 1006 may be configured for receiving one or more first user action data associated with a first user action and a first user action instance of the first user action of the user from the user device 1102. Moreover, the first user action at the first user action instance corresponds to the first action at the first action instance of the first virtual representation. Moreover, the extended reality device 1104 may be configured for rendering a first interaction between the user and the first virtual representation based on the one or more first user action data and the one or more first action data.

Furthermore, the communication device 1006 may be configured for receiving one or more pet information associated with the real pet from the user device 1102. Also, the processing device 1004 may be further configured for analyzing the one or more pet information. Also, the processing device 1004 may be configured for determining one or more attributes of the real pet based on the analyzing of the one or more pet information. Also, the generating of the first session data may be further based on the one or more attributes.

In some embodiments, the user device further 1102 includes one or more imaging sensors 1106 (as shown in FIG. 11). Furthermore, the one or more imaging sensors 1106 may be configured for generating the one or more pet information by imaging the real pet.

Accordingly, the communication device 1006 may be configured for receiving one or more pet information associated with the real pet from the user device 1102. Further, the communication device 1006 may be configured for transmitting the at least one attribute to the user device 1102. Additionally, the rendering of the first interaction may be further based on the one or more attributes. Accordingly, the processing device 1004 may be further configured for analyzing the one or more pet information. Also, the processing device 1004 may be further configured for determining the one or more attributes of the real pet based on the analyzing of the one or more pet information. Accordingly, the generating of the first session data may be further based on the one or more attributes.

Moreover, the communication device 1006 may be configured for receiving one or more user information associated with the user from the user device 1102. Further, the processing device 1004 may be configured for analyzing the one or more user information. Further, the processing device 1004 may be configured for determining one or more user attributes of the user based on the analyzing of the one or more user information. Further, the generating of the first session data may be based on the one or more user attributes.

Further, in some embodiments, the communication device 1006 may be configured for receiving one or more environment information associated with an environment of the user from the user device 1102. Furthermore, the processing device 1004 may be configured for analyzing the one or more environment information. Furthermore, the processing device 1004 may be further configured for determining one or more environment attributes of the environment based on the analyzing of the one or more environment information. Furthermore, the generating of the first session data may be based on the one or more environment attributes.

In some embodiments, the processing device 1004 may be configured for initiating the first session of the one or more sessions based on the request. Also, the generating of the first session data of the first session may be based on the initiating.

Additionally, the processing device 1004 may be further configured for analyzing the one or more first action data, the one or more first user action data, and the first session data. Also, the processing device 1004 may be further configured for determining a learning status of the user corresponding to the first session. Further, the processing device 1004 may be configured for terminating the first session based on the learning status.

Accordingly, the processing device 1004 may be further configured for identifying a second session from the one or more sessions for the user to learn the training of the pets with a second behavior of the one or more pet behaviors based on the terminating of the first session and the learning status. Further, the processing device 1004 may be configured for generating a second session data of the second session based on the identifying of the second session and the training data. Additionally, the second session data may include a second virtual representation of one or more of the pet, the one or more objects, and the assistant. Accordingly, the second session data further may include one or more second action data associated with a second action and a second action instance of the second action of the second virtual representation. Accordingly, the communication device 1006 may be further configured for transmitting the second session data to the user device 1102. Accordingly, the extended reality device 1104 may be configured for rendering the second virtual representation and the second action of the second virtual representation at the second action instance. Also, the communication device 1006 may be configured for receiving one or more second user action data associated with a second user action and a second user action instance of the user from the user device 1102. Accordingly, the second user action at the second user action instance corresponds to the second action at the second action instance. Accordingly, the extended reality device 1104 may be configured for rendering a second interaction between the user and the second virtual representation based on the one or more second user action data and the one or more second action data.

In some embodiments, the first action includes a pet action associated with the pet, an object action associated with the one or more objects, and an assistant action associated with the assistant. Additionally, the first action instance includes a pet action instance associated with the pet action, an object action instance associated with the object instance, and an assistant action instance associated with the assistant action. Additionally, the assistant action at the assistant action instance prompts the first user action at the first user action instance. Additionally, the first user action at the first user action instance corresponds to one or more of the pet action at the pet action instance and the object action at the object action instance. Additionally, the extended reality device 1104 may be further configured for rendering one or more prompts for the user based on the assistant action at the assistant action instance. Additionally, the user device 1102 further includes at least one input device which may be configured for capturing the first user action at the first user action instance for the one or more prompts for generating the one or more first user action data.

FIG. 11 illustrates a block diagram of the system 1000 of facilitating users to learn training pets, in accordance with some embodiments.

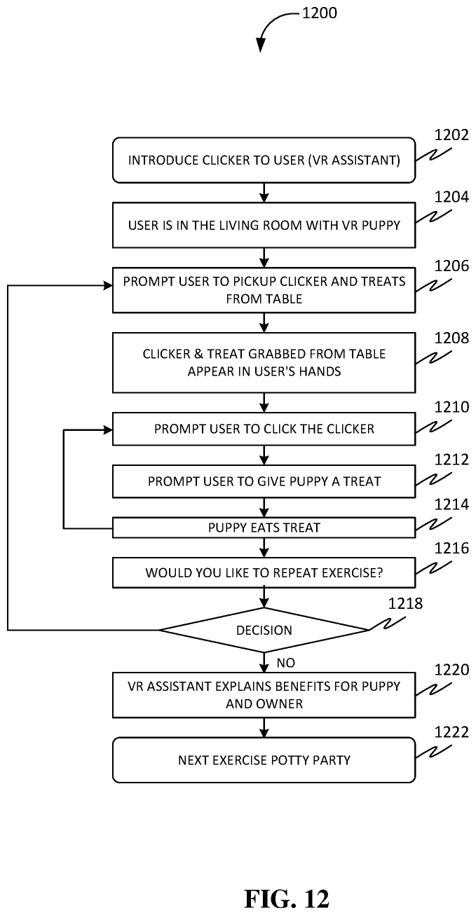

FIG. 12 is a flow diagram of a method 1200 of facilitating users to learn training pets, in accordance with some embodiments. Accordingly, at 1202, the method 1200 may include introducing a clicker to a user (VR assistant). Further, the method 1200 may use or employ a speaking VR assistant that explains instructions. Further, the VR assistant may be hovering on a screen that may be comprised in a smartphone. Further, at 1204, the method 1200 may include a user being in a living room with a VR puppy. Further, at 1206, the method 1200 may include prompting the user to pick up the clicker and treats from a table. Further, at 1208, the method 1200 may include the clicker and a treat being grabbed from the table in hands of the user. Further, at 1210, the method 1200 may include prompting the user to click the clicker. Further, at 1212, the method 1200 may include prompting the user to give a treat to the puppy. Further, at 1214, the method 1200 may include the puppy eating the treat. Further, in some embodiments, the method 1200 may include repeating steps 1210-1214 three times. Further, in some embodiments, after 1214, the method 1200 may proceed to 1210. Further, at 1216, the method 1200 may include asking the user whether the user wants to repeat the exercise. Further, at 1218, the method 1200 may include receiving a decision from the user. Further, after 1218, if the decision is yes, the method 1200 may proceed to 1206. Further, after 1218, if the decision is no, at 1220, the method 1200 may include the VR assistant explaining benefits for the puppy and an owner (or the user). Further, at 1222, the method 1200 may include a next exercise (such as a potty party).

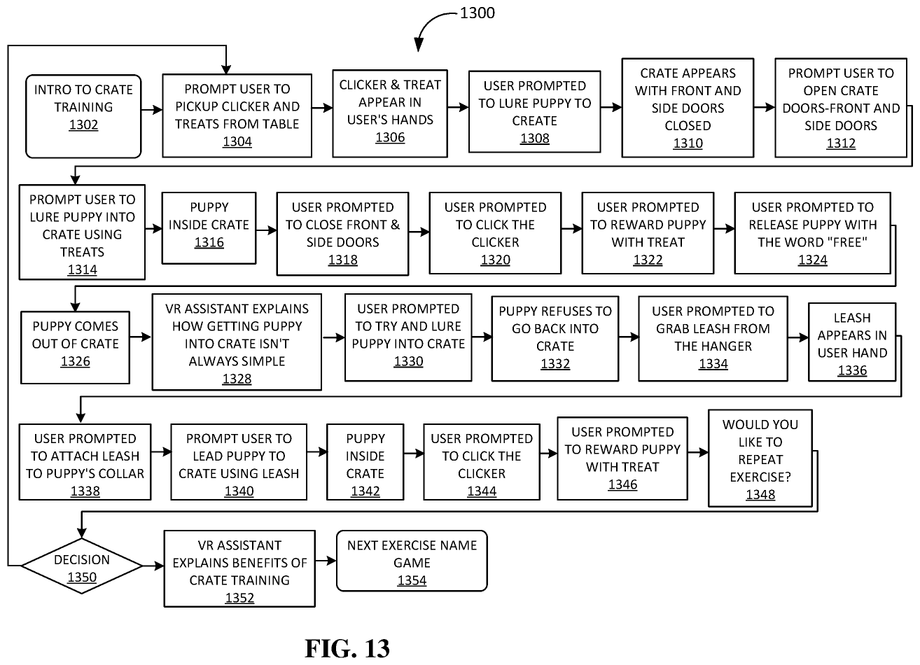

FIG. 13 is a flow diagram of a method 1300 of facilitating users to learn training pets, in accordance with some embodiments. Accordingly, at 1302, the method 1300 may include introducing crate training. Further, the method 1300 may use or employ a speaking VR assistant that explains instructions. Further, at 1304, the method 1300 may include prompting a user to pick up a clicker and treats from a table. Further, at 1306, the method 1300 may include the clicker and treat appearing in hands of the user. Further, at 1308, the method 1300 may include prompting the user to lure a puppy to a crate. Further, at 1310, the method 1300 may include the crate appearing with front and side doors closed. Further, at 1312, the method 1300 may include prompting the user to open the crate doors (front and side doors). Further, at 1314, the method 1300 may include prompting the user lure the puppy into crate using the treats. Further, at 1316, the method 1300 may include the puppy getting inside the crate. Further, at 1318, the method 1300 may include prompting the user to close the front and side doors. Further, at 1320, the method 1300 may include prompting the user to click the clicker. Further, at 1322, the method 1300 may include prompting the user to reward the puppy with the treat. Further, at 1324, the method 1300 may include prompting the user to release the puppy with the word “free”. Further, at 1326, the method 1300 may include the puppy coming out of the crate. Further, at 1328, the method 1300 may include a VR assistant explaining how getting the puppy into the crate isn't simple always. Further, at 1330, the method 1300 may include prompting the user to try and lure the puppy into the crate. Further, at 1332, the method 1300 may include the puppy refusing to go back into the crate. Further, at 1334, the method 1300 may include prompting the user to grab a leash from a hanger. Further, at 1336, the method 1300 may include the leash appearing in the hands of the user. Further, at 1338, the method 1300 may include prompting the user to attach the leash to a collar of the puppy. Further, at 1340, the method 1300 may include prompting the user to lead the puppy to the crate using the leash. Further, at 1342, the method 1300 may include the puppy getting inside the crate. Further, at 1344, the method 1300 may include prompting the user to click the clicker. Further, at 1346, the method 1300 may include prompting the user to reward the puppy with the treat. Further, at 1348, the method 1300 may include confirming whether the user would like to repeat the exercise. Further, if the user wants to repeat the exercise, the method 1300 may proceed to 1304. Further, after 1348, if the user does not want to repeat the exercise, at 1350, the method 1300 may include a decision. Further, at 1352, the method 1300 may include the VR assistant explaining benefits of the crate training. Further, at 1354, the method 1300 may include a next exercise name game.

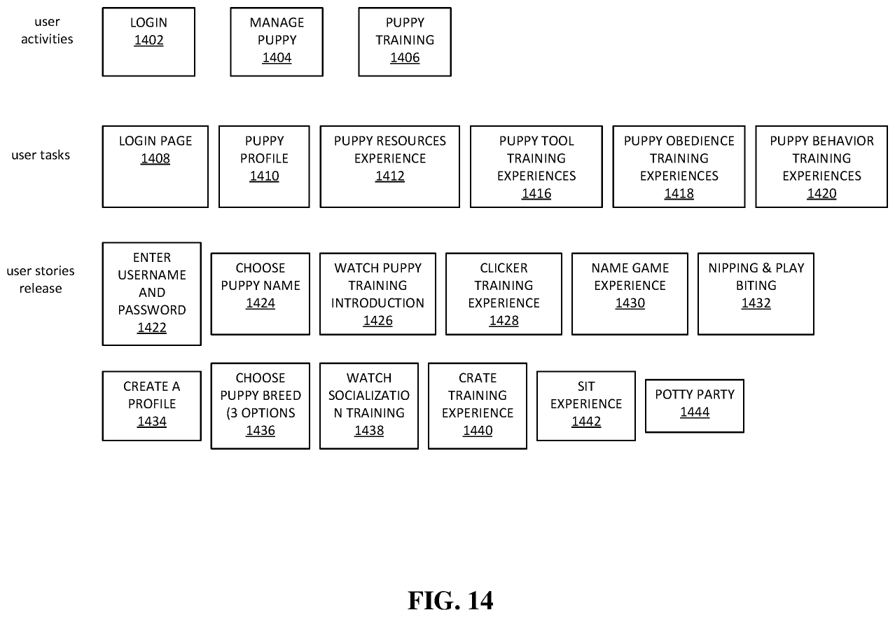

FIG. 14 is a block diagram illustrating a plurality of user activities 1402-1406, a plurality of user tasks 1408-1420, and a plurality of user stories release 1422-1444 for facilitating users to learn training pets, in accordance with some embodiments. Accordingly, the plurality of user activities 1402-1406 may include a log in 1402, managing a puppy 1404, and puppy training 1406. Further, the plurality of user tasks 1408-1420 may include a login page 1408, a puppy profile 1410, a puppy resources experience 1412, puppy tool training experiences 1416, puppy obedience training experience 1418, and puppy behavior training experiences 1420. Further, the plurality of user stories release 1422-1444 may include entering username and password 1422, choosing puppy name 1424, watching puppy training-introduction 1426, clicker training experience 1428, name game experience 1430, nipping and play biting 132, creating a profile 1434, choosing puppy breed (3 options) 1436, watching socialization training 1438, crate training experience 1440, sitting experience 1442, and potty party 1444.

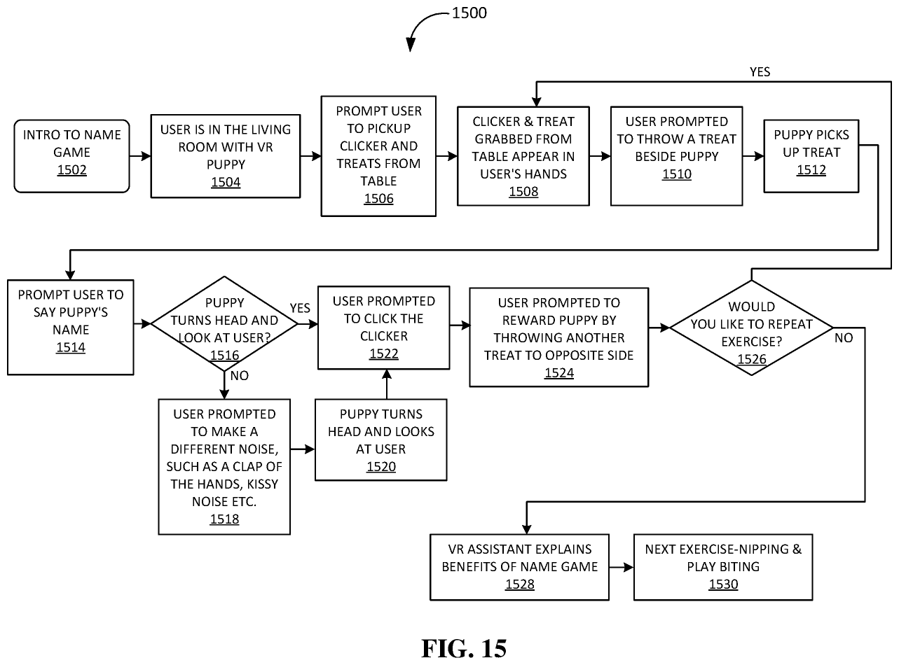

FIG. 15 is a flow diagram of a method 1500 of facilitating users to learn training pets, in accordance with some embodiments. Accordingly, at 1502, the method 1500 may include introducing to name game. Further, the method 1500 may use or employ a speaking VR assistant that explains instructions. Further, at 1504, the method 1500 may include a user in a living room with a VR puppy. Further, at 1506, the method 1500 may include prompting the user to pick up a clicker and treat from a table. Further, at 1508, the method 1500 may include the clicker and the treat grabbed from the table appearing in hands of the user. Further, at 1510, the method 1500 may include prompting the user to throw a treat beside the puppy. Further, at 1512, the method 1500 may include the puppy picking up the treat. Further, at 1514, the method 1500 may include prompting the user to say a name of the puppy. Further, at 1516, the method 1500 may include confirming whether the puppy turns its head and looks at the user. Further, if the puppy turns the head and looks at the user, at 1522, the method 1500 may include prompting the user to click the clicker. Further, in some embodiments, if the puppy does not turn the head and doesn't look at the user, after 1516, at 1518, the method 1500 may include prompting the user to make a noise such as clasp of the hands, kissy noise, etc. Further, at 1520, the method 1500 may include confirming whether the puppy turns head and looks at the user. Further, after 1520, the method 1500 may proceed to 1522. Further, at 1524, the method 1500 may include prompting the user to reward the puppy by throwing another treat to opposite side. Further, at 1526, the method 1500 may include confirming whether the user would like to repeat the exercise. Further, if the user would like to repeat the exercise, after 1526, the method 1500 may proceed to 1508. Further, if the user would not like to repeat the exercise, after 1526, at 1528, the method 1500 may include the VR assistant explaining benefits of the name game. Further, at 1530, the method 1500 may include a new exercise—nipping and play biting.

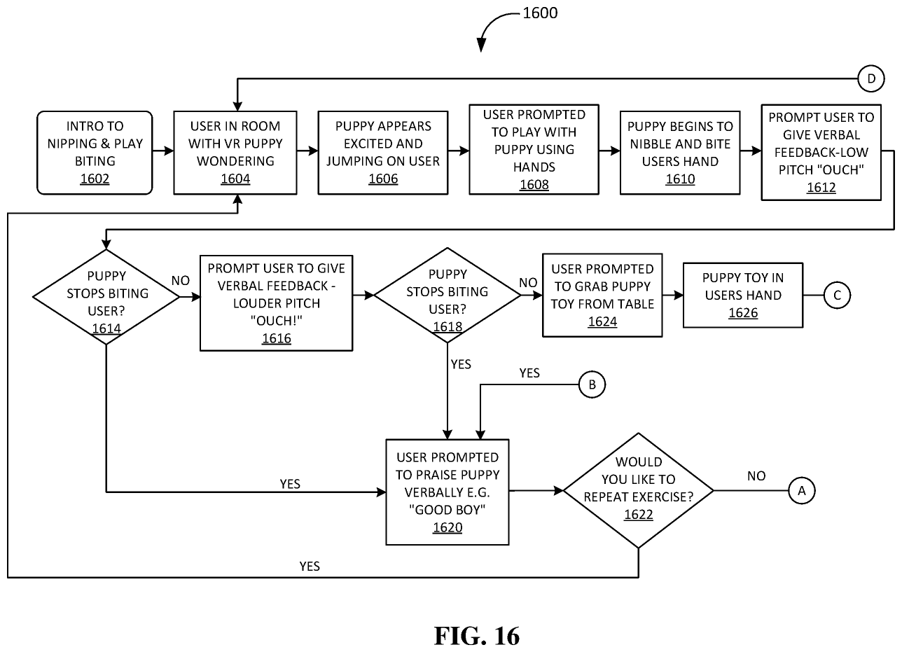

FIG. 16 is a flow diagram of a method 1600 of facilitating users to learn training pets, in accordance with some embodiments. Accordingly, at 1602, the method 1600 may include introduction to nipping and play biting. Further, the method 1600 may use or employ a speaking VR assistant that explains instructions. Further, at 1604, the method 1600 may include a user in a room with a VR puppy wondering. Further, at 1606, the method 1600 may include the puppy appearing excited and jumping on the user. Further, at 1608, the method 1600 may include prompting the user to play with the puppy using the hands. Further, at 1610, the method 1600 may include the puppy beginning to nibble and bite hands of the user. Further, at 1612, the method 1600 may include prompting the user to give verbal feedback such as low pitch “ouch”. Further, at 1614, the method 1600 may include checking if the puppy stops biting the user. Further, if the puppy stops biting, the method 1600 may proceed to 1620. Further, if the puppy doesn't stop biting, at 1616, the method 1600 may include prompting the user to give verbal feedback such as a louder pitch “ouch”. Further, at 1618, the method 1600 may include confirming if the puppy stopped biting the user. Further, if the puppy stopped biting the user, at 1620, the method 1600 may include prompting the user to praise the puppy verbally with words such as “good boy”. Further, at 1622, the method 1600 may include checking if the user would like to repeat the exercise. Further, if the user wants to repeat the exercise, the method 1600 may proceed to 1604. Further, if the user does not want to repeat the exercise, after 1622, at 1634, the method 1600 may include the VR assistant explaining benefits of nipping & play biting correction. Further, at 1636, the method 1600 may include next exercise “sit”. Further, at 1618, if the puppy does not stop biting, the method 1600 may include prompting the user to grab a puppy toy from the table at 1624. Further, at 1626, the method 1600 may include the puppy toy in the hands of the user. Further, at 1627, the method 1600 may include prompting the user to give the toy to the puppy. Further, at 1628, the method 1600 may include checking if the puppy stops biting the user. Further, if the puppy stopped biting the user, after 1628, the method 1600 may proceed to 1620. Further, if the puppy doesn't stop biting the user, at 1630, the method 1600 may include prompting the user to give the puppy a break in a side play pen with a toy. Further, at 1632, the method 1600 may include prompting the user to restart the exercise. Further, after 1632, the method may proceed to 1604.

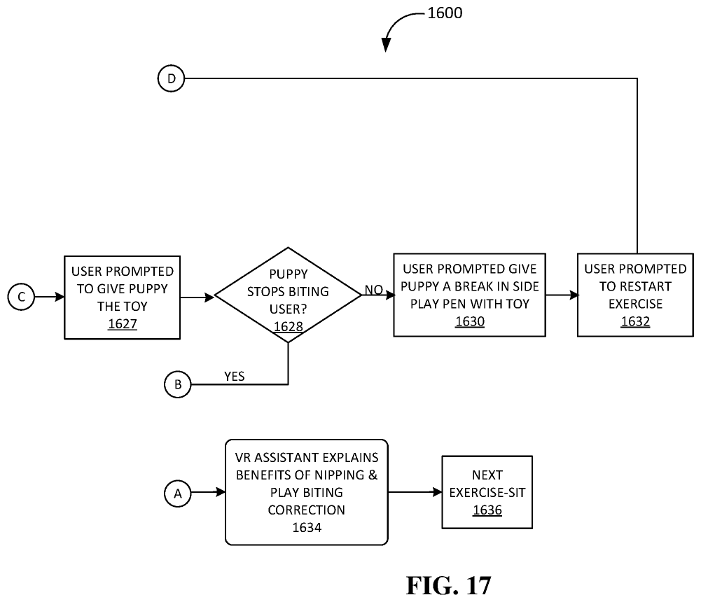

FIG. 17 is a continuation of a flow diagram of the method 1600 of facilitating users to learn training pets, in accordance with some embodiments.

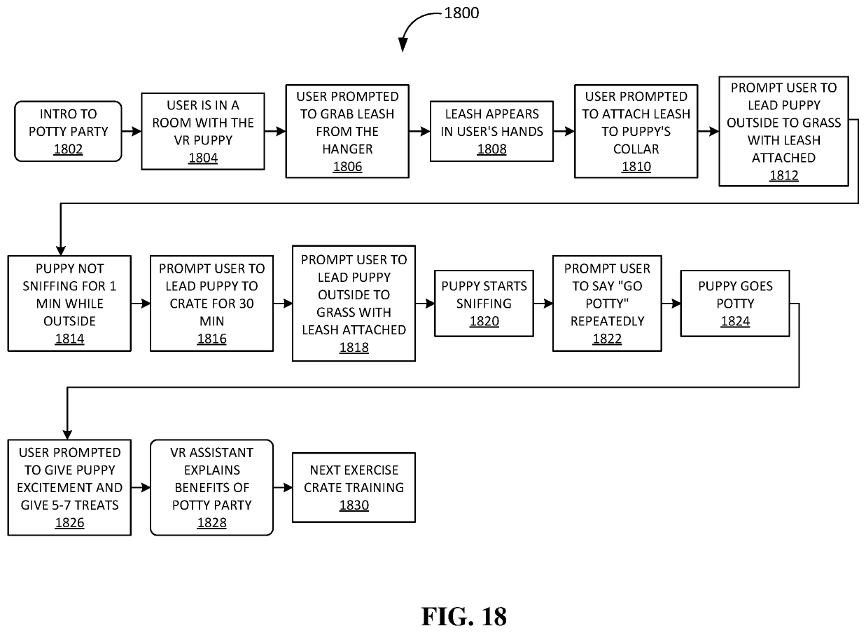

FIG. 18 is a flow diagram of a method 1800 of facilitating users to learn training pets, in accordance with some embodiments. Accordingly, at 1802, the method 1800 may include introducing to a potty party. Further, the method 1800 may use or employ a speaking VR assistant that explains instructions. Further, at 1804, the method 1800 may include the user in a room with a VR puppy. Further, at 1806, the method 1800 may include prompting the user to grab a leash from a hanger. Further, at 1808, the method 1800 may include the leash appearing in hands of the user. Further, at 1810, the method 1800 may include prompting the user to attach the leash to a collar of the puppy. Further, at 1812, the method 1800 may include prompting the user to lead the puppy outside to grass with the leash attached. Further, at 1814, the method 1800 may include the puppy not sniffing for 1 minute while outside. Further, VR assistant may explain the real time experience to be 5 minutes. Further, at 1816, the method 1800 may include prompting the user to lead the puppy to the crate for 30 minutes. Further, 30 minutes VR time may be equal to 30 seconds in real time. Further, the VR assistant may explain benefit of using the crate. Further, at 1818, the method 1800 may include prompting the user to lead the puppy outside to grass with the leash attached. Further, at 1820, the method 1800 may include the puppy starting sniffing. Further, at 1822, the method 1800 may include prompting the user to say “go potty” repeatedly. Further, at 1246, the method 1800 may include prompting the puppy to go to potty. Further, at 1826, the method 1800 may include prompting the user to give excitement and 5—treats to the puppy. Further, at 1828, the method 1800 may include the VR assistant explaining benefits of the potty party. Further, at 1830, the method 1800 may include a next exercise “crate training”.

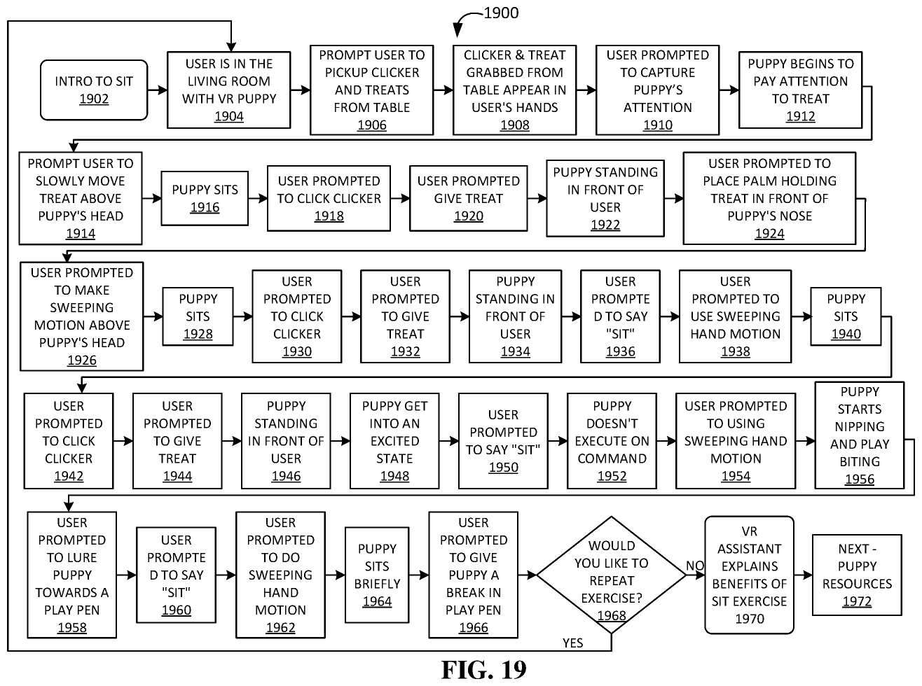

FIG. 19 is a flow diagram of a method 1900 of facilitating users to learn training pets, in accordance with some embodiments. Accordingly, at 1902, the method 1900 may include introducing to sitting. Further, the method 1900 may use or employ a speaking VR assistant that explains instructions. Further, at 1904, the method 1900 may include the user in a living room with a VR puppy. Further, at 1906, the method 1900 may include prompting the user to pick up a clicker and treat from a table. Further, at 1908, the method 1900 may include the clicker and the treat grabbed from the table appearing in hands of the user. Further, at 1910, the method 1900 may include prompting the user to capture puppy's attention. Further, at 1912, the method 1900 may include the puppy beginning to pay attention to the treat. Further, at 1914, the method 1900 may include prompting the user to slowly move the treat above a head of the puppy. Further, at 1916, the method 1900 may include the puppy sitting. Further, at 1918, the method 1900 may include prompting the user to click the clicker. Further, at 1920, the method 1900 may include prompting the user to give the treat. Further, at 1922, the method 1900 may include the puppy standing in front of the user. Further, at 1924, the method 1900 may include prompting the user to place palm holding the treat in front of a nose of the puppy. Further, at 1926, the method 1900 may include prompting the user to make a sweeping motion above the puppy's head. Further, at 1928, the method 1900 may include the puppy sitting. Further, at 1930, the method 1900 may include prompting the user to click the clicker. Further, at 1932, the method 1900 may include prompting the user to give the treat. Further, at 1934, the method 1900 may include the puppy standing in front of the user. Further, at 1936, the method 1900 may include prompting the user to say “sit”. Further, at 1938, the method 1900 may include prompting the user to use sweeping hand motion. Further, at 1940, the method 1900 may include the puppy sitting. Further, at 1942, the method 1900 may include prompting the user to click the clicker. Further, at 1944, the method 1900 may include prompting the user to give the treat. Further, at 1946, the method 1900 may include the puppy standing in front of the user. Further, at 1948, the method 1900 may include the puppy getting into an excited state. Further, at 1950, the method 1900 may include the user being prompted to say “sit”. Further, at 1952, the method 1900 may include the puppy not executing on a command. Further, at 1954, the method 1900 may include prompting the user to use sweeping a hand motion. Further, at 1956, the method 1900 may include the puppy starting nipping and playing with biting. Further, at 1958, the method 1900 may include prompting the user to lure the puppy toward a play pen. Further, at 1960, the method 1900 may include prompting the user to say “sit”. Further, at 1962, the method 1900 may include prompting the user to do a sweeping hand motion. Further, at 1964, the method 1900 may include the puppy sitting briefly. Further, at 1966, the method 1900 may include prompting the user to give the puppy a break in a play pen. Further, at 1968, the method 1900 may include checking if the user wants to repeat the exercise. Further, if the user doesn't want to repeat the exercise, after 1968, at 1970, the method 1900 may include the VR assistant explaining benefits of sit exercise. Further, at 1972, the method 1900 may include proceeding to next puppy resources. Further, if the user wants to repeat the exercise, after 1968, the method 1900 may proceed to 1904.

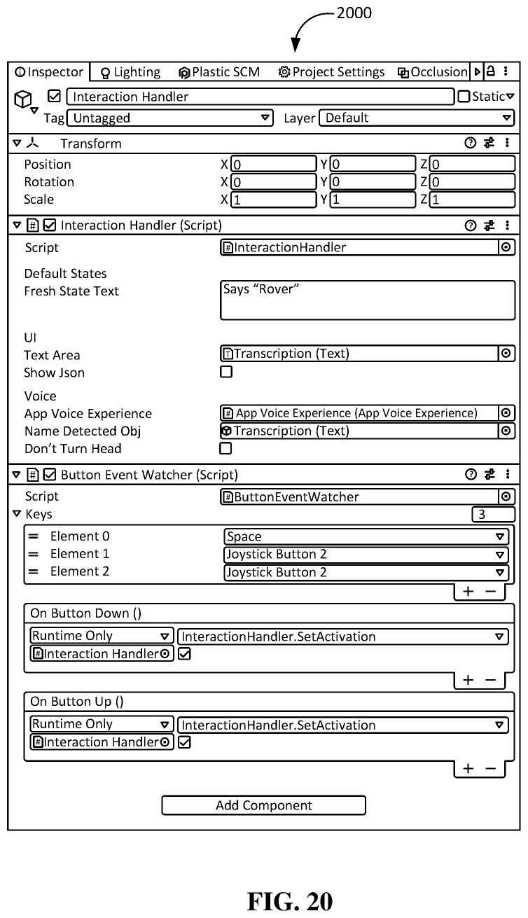

FIG. 20 is a screenshot of a user interface 2000 of a software application associated with the system of facilitating users to learn training pets, in accordance with some embodiments. Accordingly, the user interface 2000 may display a unity inspector view. Further, the disclosed system may be associated with scripts responsible for voice detection.

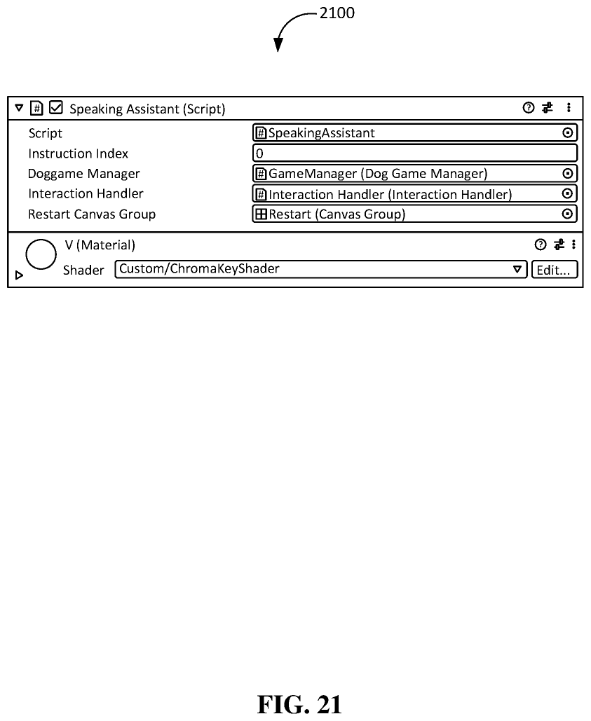

FIG. 21 is a screenshot of a user interface 2100 of the software application associated with the system of facilitating users to learn training pets, in accordance with some embodiments. Accordingly, the user interface 2100 may display a speaking assistant script that manages a video and plays the video every time the user does one step and then pause the video until the user does another. Further, the speaking assistant script may include a reference to a voice detection script, so, at certain points, the speaking assistant script enables voice detection.

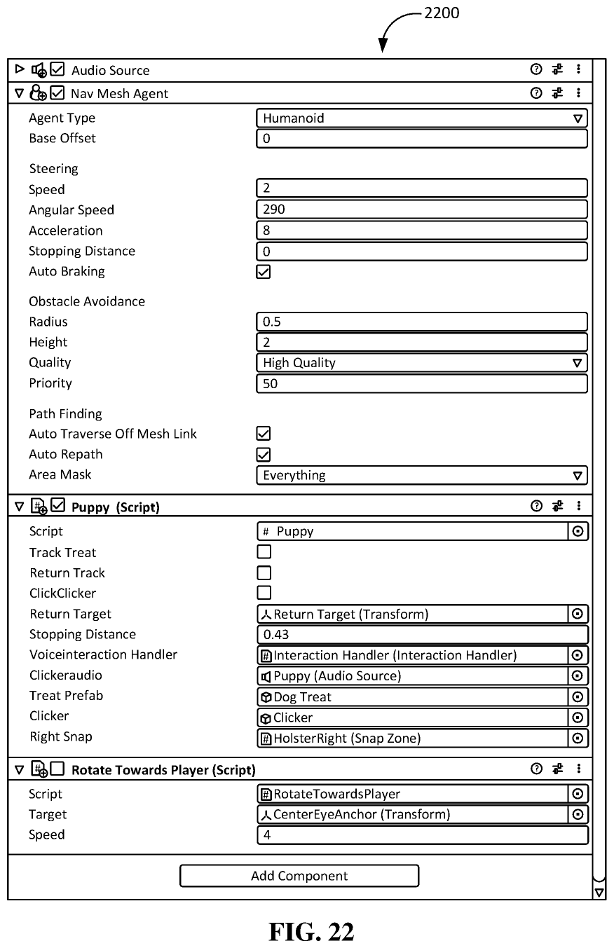

FIG. 22 is a screenshot of a user interface 2200 of the software application associated with the system of facilitating users to learn training pets, in accordance with some embodiments. Accordingly, the software application may be associated with one or more scripts. Further, the one or more scripts may include a script named “puppy” for managing when the puppy track, treat, return, or responds on the clicker. Further, the one or more scripts may include a unity script (Nav Mesh Agent) for walking around and finding a proper path to reach a treat.

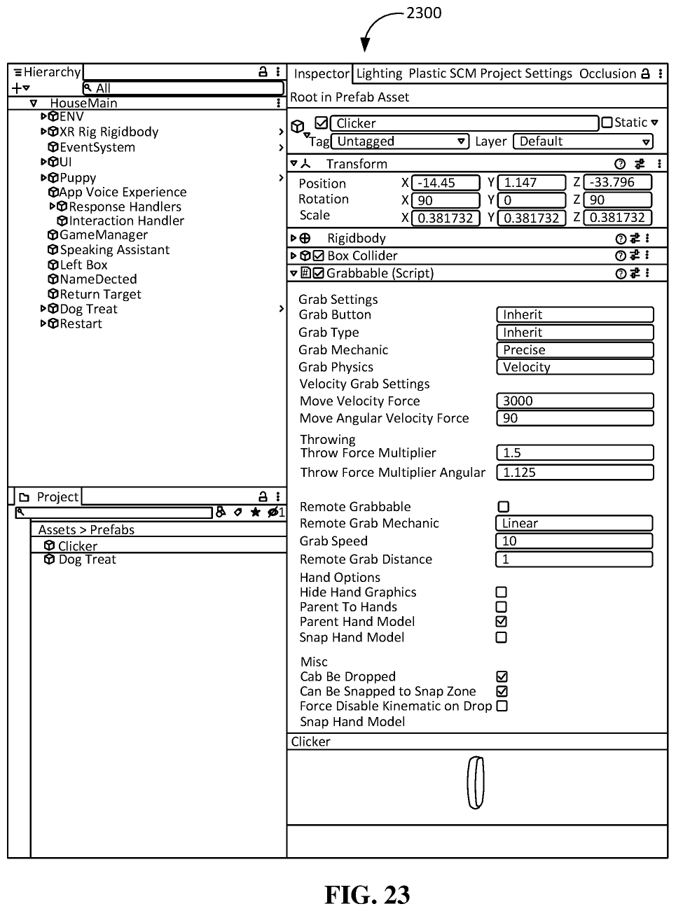

FIG. 23 is a screenshot of a user interface 2300 of the software application associated with the system of facilitating users to learn training pets, in accordance with some embodiments. Accordingly, a clicker and a dog treat script may be prefab inside unity which may be spawned at an appropriate time. Further, both the clicker and the dog treat script may include grabbable scripts to allow the user to grab them with proper physics and also another treat script for sending a signal to an assistant manager script if the user has picked them.

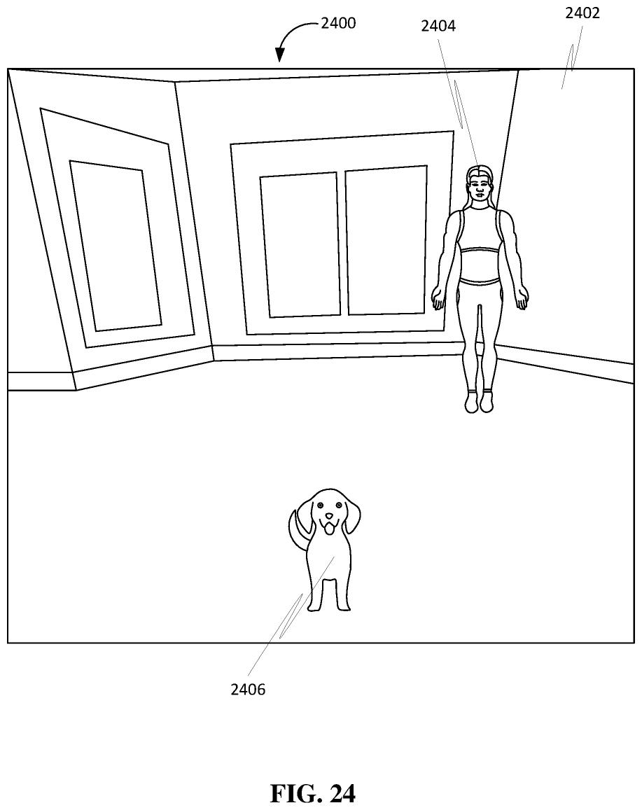

FIG. 24 is a screenshot of a user interface 2400 illustrating a virtual representation of a pet 2406 and an assistant 2404 in a virtual reality environment 2402, in accordance with some embodiments. Further, the assistant 2404 may perform an assistant action and the pet 2406 may perform a pet action.

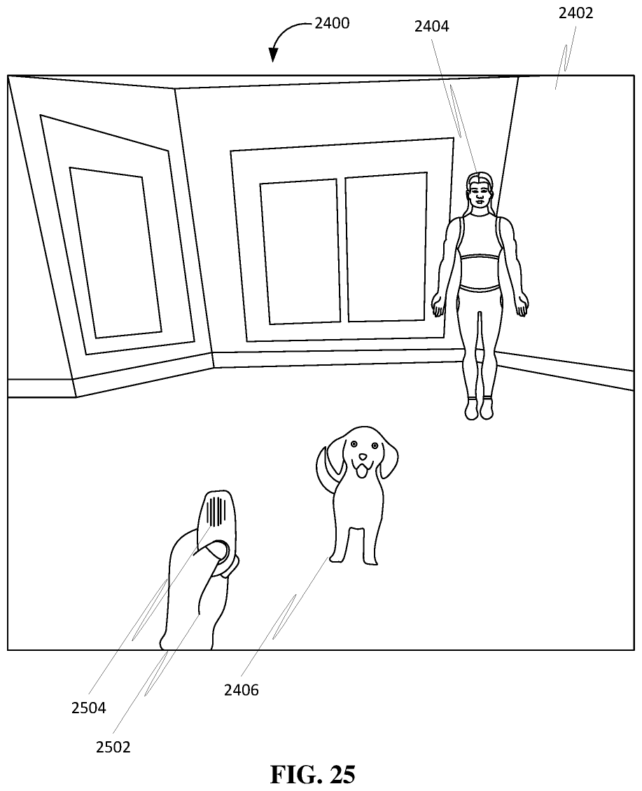

FIG. 25 is a screenshot of the user interface 2400 further illustrating a virtual representation of a user (2502 and 2602) holding a clicker 2504 in the virtual reality environment 2402, in accordance with some embodiments. Further, the assistant 2404 instructs the user (2502 and 2602) to hold the clicker 2504. Further, the assistant 2404 may perform the assistant action and the pet 2406 may perform the pet action allowing the user (2502 and 2602) to learn training the pet 2406 with one or more pet behaviors.

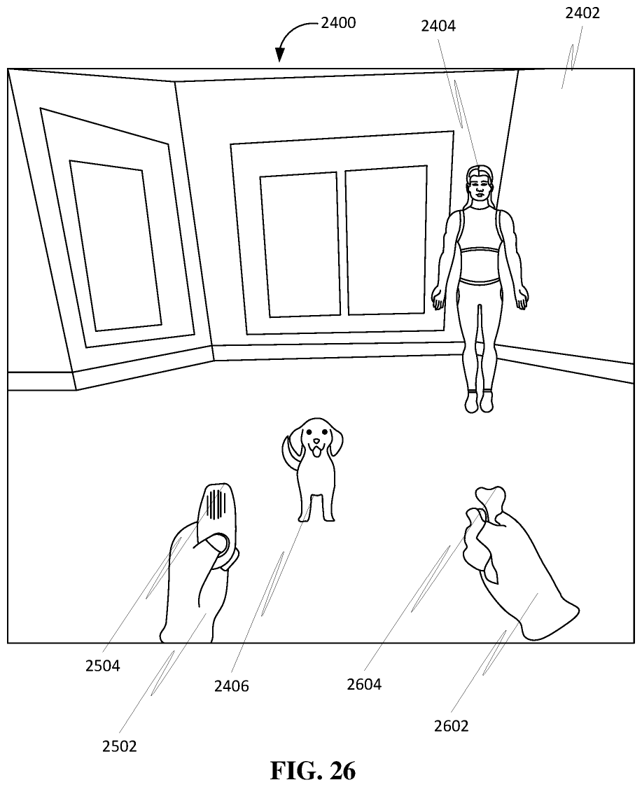

FIG. 26 is a screenshot of the user interface 2400 further illustrating a virtual representation of the user (2502 and 2602) holding a treat 2604 in the virtual reality environment 2402, in accordance with some embodiments. Further, the assistant 2404 instructs the user (2502 and 2602) to hold the treat 2604.

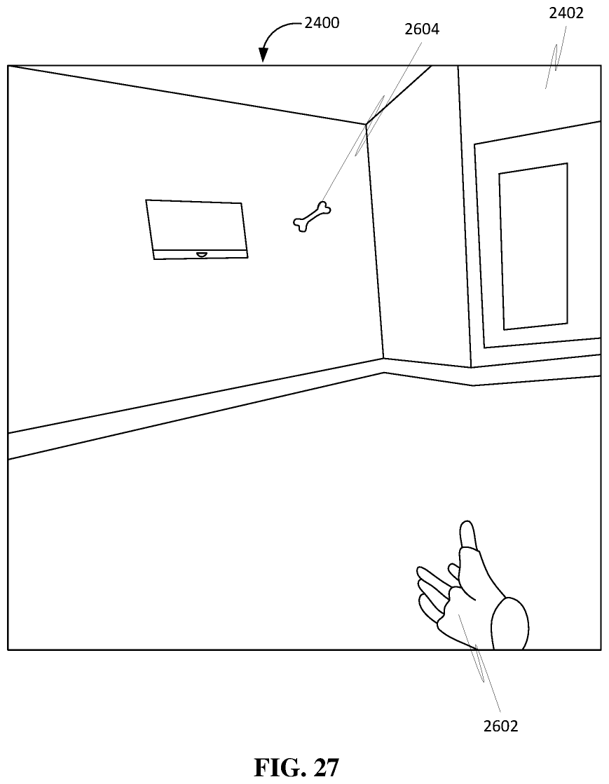

FIG. 27 is a screenshot of the user interface 2400 further illustrating a virtual representation of the user (2502 and 2602) throwing the treat 2604 in a first direction in the virtual reality environment 2402, in accordance with some embodiments. Further, the assistant 2404 instructs the user (2502 and 2602) to throw the treat 2604 in the first direction.

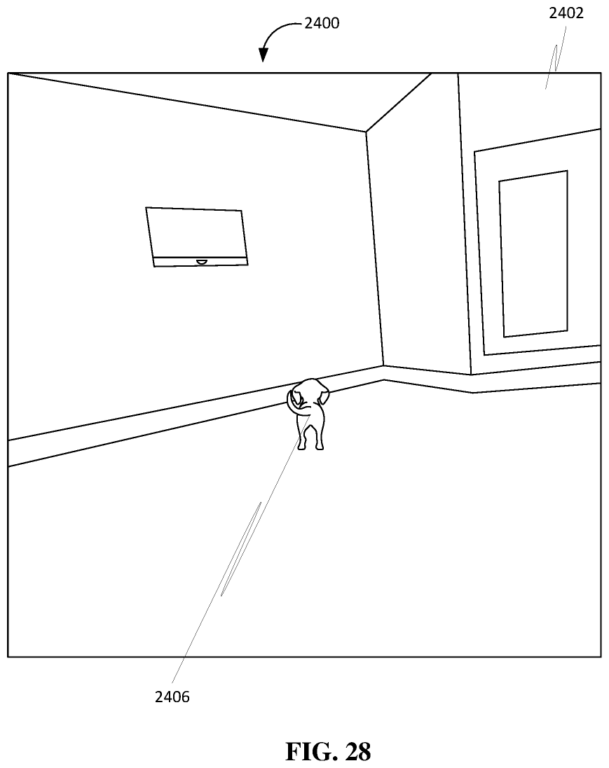

FIG. 28 is a screenshot of the user interface 2400 further illustrating a virtual representation of the pet 2406 moving toward the treat 2604 in the virtual reality environment 2402, in accordance with some embodiments.

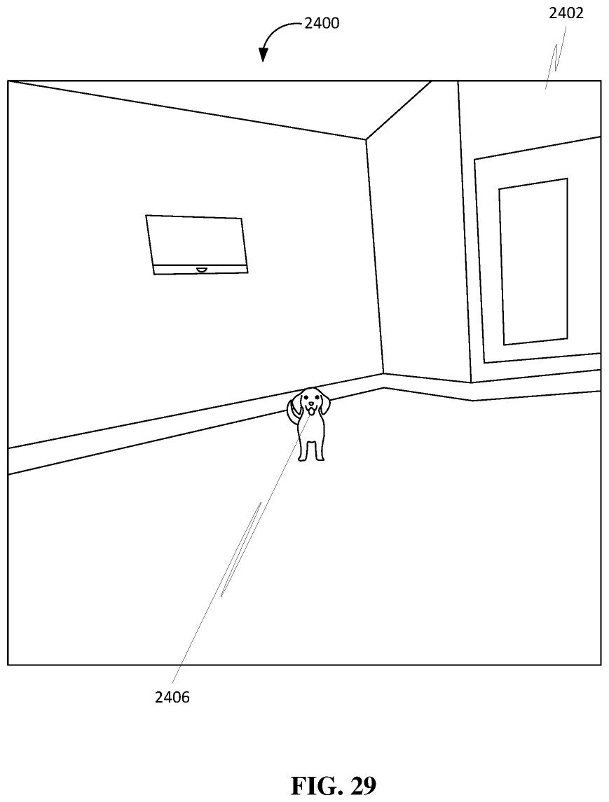

FIG. 29 is a screenshot of the user interface 2400 further illustrating a virtual representation of the pet 2406 facing the user (2502 and 2602) due to an utterance from the user (2502 and 2602) in the virtual reality environment 2402, in accordance with some embodiments. Further, the assistant 2404 instructs the user (2502 and 2602) to utter the utterance.

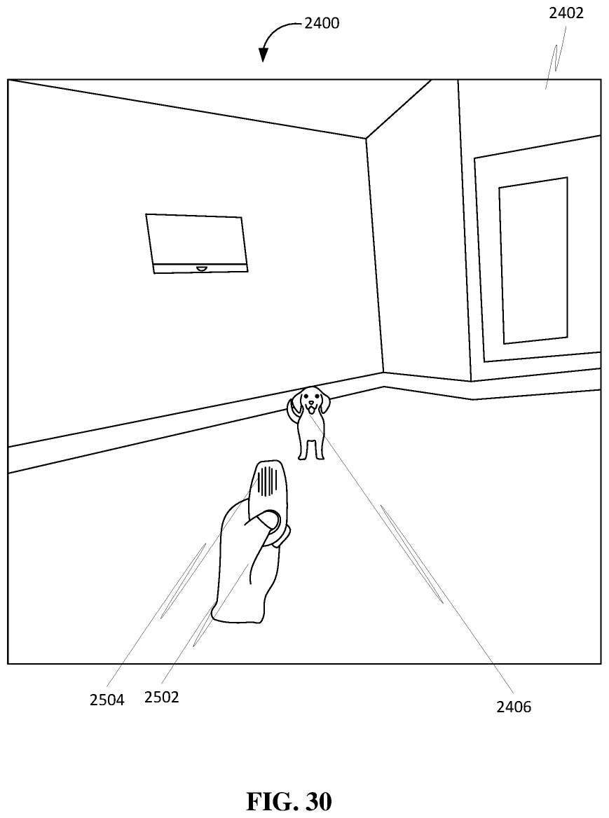

FIG. 30 is a screenshot of the user interface 2400 further illustrating a virtual representation of the user (2502 and 2602) clicking the clicker 2504 in the virtual reality environment 2402 after the utterance, in accordance with some embodiments. Further, the assistant 2404 instructs the user (2502 and 2602) to click the clicker 2504.

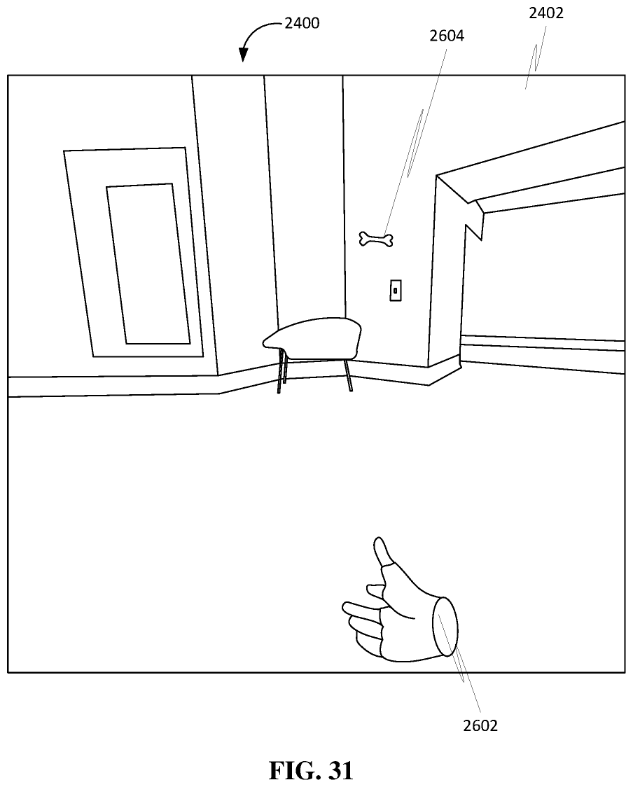

FIG. 31 is a screenshot of the user interface 2400 further illustrating a virtual representation of the user (2502 and 2602) throwing the treat 2604 in a second direction opposite to the first direction in the virtual reality environment 2402, in accordance with some embodiments. Further, the assistant 2404 instructs the user (2502 and 2602) to throw the treat 2604 in the second direction.

Although the invention has been explained in relation to its preferred embodiment, it is to be understood that many other possible modifications and variations can be made without departing from the spirit and scope of the invention as hereinafter claimed.

1. A method of facilitating users to learn training pets, wherein the method comprises:
receiving, using a communication device, a request from a user to learn training a real pet from a user device;
retrieving, using a storage device, a training data associated with the training of the pets based on the request, wherein the training data comprises one or more sessions for the user to learn the training of the pets with one or more pet behaviors;
generating, using a processing device, a first session data of a first session of the one or more sessions for the user to learn the training of the real pet with a first pet behavior of the one or more pet behaviors based on the request and the training data, wherein the first session data comprises a first virtual representation of at least one of a pet, at least one object, and an assistant, wherein the first session data further comprises at least one first action data associated with a first action and a first action instance of the first action of the first virtual representation;
transmitting, using the communication device, the first session data to the user device, wherein the user device comprises an extended reality device, wherein the extended reality device is configured for rendering the first virtual representation and the first action of the first virtual representation at the first action instance; and
receiving, using the communication device, at least one first user action data associated with a first user action and a first user action instance of the first user action of the user from the user device, wherein the first user action at the first user action instance corresponds to the first action at the first action instance of the first virtual representation, wherein the extended reality device is further configured for rendering a first interaction between the user and the first virtual representation based on the at least one first user action data and the at least one first action data.

2. The method of claim 1 further comprises:
receiving, using the communication device, at least one pet information associated with the real pet from the user device;
analyzing, using the processing device, the at least one pet information; and
determining, using the processing device, at least one attribute of the real pet based on the analyzing of the at least one pet information, wherein the generating of the first session data is further based on the at least one attribute.

3. The method of claim 2 wherein the user device further comprises at least one imaging sensor, wherein the at least one imaging sensor is configured for generating the at least one pet information by imaging the real pet.

4. The method of claim 1 further comprises:
receiving, using the communication device, at least one pet information associated with the real pet from the user device;
analyzing, using the processing device, the at least one pet information;
determining, using the processing device, at least one attribute of the real pet based on the analyzing of the at least one pet information; and
transmitting, using the communication device, the at least one attribute to the user device, wherein the rendering of the first interaction is further based on the at least one attribute.

5. The method of claim 1 further comprises:
receiving, using the communication device, at least one user information associated with the user from the user device;
analyzing, using the processing device, the at least one user information; and
determining, using the processing device, at least one user attribute of the user based on the analyzing of the at least one user information, wherein the generating of the first session data is further based on the at least one user attribute.

6. The method of claim 1 further comprises:
receiving, using the communication device, at least one environment information associated with an environment of the user from the user device;
analyzing, using the processing device, the at least one environment information; and
determining, using the processing device, at least one environment attribute of the environment based on the analyzing of the at least one environment information, wherein the generating of the first session data is further based on the at least one environment attribute.

7. The method of claim 1 further comprising initiating, using the processing device, the first session of the one or more sessions based on the request, wherein the generating of the first session data of the first session is further based on the initiating.

8. The method of claim 7 further comprises:
analyzing, using the processing device, the at least one first action data, the at least one first user action data, and the first session data;
determining, using the processing device, a learning status of the user corresponding to the first session; and
terminating, using the processing device, the first session based on the learning status.

9. The method of claim 8 further comprises:
identifying, using the processing device, a second session from the one or more sessions for the user to learn the training of the pets with a second behavior of the one or more pet behaviors based on the terminating of the first session and the learning status;
generating, using the processing device, a second session data of the second session based on the identifying of the second session and the training data, wherein the second session data comprises a second virtual representation of at least one of the pet, the at least one object, and the assistant, wherein the second session data further comprises at least one second action data associated with a second action and a second action instance of the second action of the second virtual representation;
transmitting, using the communication device, the second session data to the user device, wherein the extended reality device is further configured for rendering the second virtual representation and the second action of the second virtual representation at the second action instance; and
receiving, using the communication device, at least one second user action data associated with a second user action and a second user action instance of the user from the user device, wherein the second user action at the second user action instance corresponds to the second action at the second action instance, wherein the extended reality device is further configured for rendering a second interaction between the user and the second virtual representation based on the at least one second user action data and the at least one second action data.

10. The method of claim 1 wherein the first action comprises a pet action associated with the pet, an object action associated with the at least one object, and an assistant action associated with the assistant, wherein the first action instance comprises a pet action instance associated with the pet action, an object action instance associated with the object instance, and an assistant action instance associated with the assistant action, wherein the assistant action at the assistant action instance prompts the first user action at the first user action instance, wherein the first user action at the first user action instance corresponds to at least one of the pet action at the pet action instance and the object action at the object action instance, wherein the extended reality device is further configured for rendering at least one prompt for the user based on the assistant action at the assistant action instance, wherein the user device further comprises at least one input device configured for capturing the first user action at the first user action instance for the at least one prompt for generating the at least one first user action data.

11. A system for facilitating users to learn training pets, the system comprising:
a storage device configured for retrieving a training data associated with the training of the pets based on a request, wherein the training data comprises one or more sessions for the user to learn the training of the pets with one or more pet behaviors;
a processing device communicatively coupled with the storage device, wherein the processing device is configured for generating a first session data of a first session of the one or more sessions for the user to learn the training of the real pet with a first pet behavior of the one or more pet behaviors based on the request and the training data, wherein the first session data comprises a first virtual representation of at least one of a pet, at least one object, and an assistant, wherein the first session data further comprises at least one first action data associated with a first action and a first action instance of the first action of the first virtual representation; and
a communication device communicatively coupled with the processing device, wherein the communication device is configured for:
receiving the request from a user to learn training a real pet from a user device;
transmitting the first session data to the user device, wherein the user device comprises an extended reality device, wherein the extended reality device is configured for rendering the first virtual representation and the first action of the first virtual representation at the first action instance; and
receiving at least one first user action data associated with a first user action and a first user action instance of the first user action of the user from the user device, wherein the first user action at the first user action instance corresponds to the first action at the first action instance of the first virtual representation, wherein the extended reality device is further configured for rendering a first interaction between the user and the first virtual representation based on the at least one first user action data and the at least one first action data.

12. The system of claim 11, wherein the communication device is further configured for receiving at least one pet information associated with the real pet from the user device, wherein the processing device is further configured for:
analyzing the at least one pet information; and
determining at least one attribute of the real pet based on the analyzing of the at least one pet information, wherein the generating of the first session data is further based on the at least one attribute.

13. The system of claim 12 wherein the user device further comprises at least one imaging sensor, wherein the at least one imaging sensor is configured for generating the at least one pet information by imaging the real pet.

14. The system of claim 11, wherein the communication device is further configured for:
receiving at least one pet information associated with the real pet from the user device;
transmitting the at least one attribute to the user device, wherein the rendering of the first interaction is further based on the at least one attribute, wherein the processing device is further configured for:
analyzing the at least one pet information; and
determining the at least one attribute of the real pet based on the analyzing of the at least one pet information, wherein the generating of the first session data is further based on the at least one attribute.

15. The system of claim 11, wherein the communication device is further configured for receiving at least one user information associated with the user from the user device, wherein the processing device is further configured for:
analyzing the at least one user information; and
determining at least one user attribute of the user based on the analyzing of the at least one user information, wherein the generating of the first session data is further based on the at least one user attribute.

16. The system of claim 11, wherein the communication device is further configured for receiving at least one environment information associated with an environment of the user from the user device, wherein the processing device is further configured for:
analyzing the at least one environment information; and
determining at least one environment attribute of the environment based on the analyzing of the at least one environment information, wherein the generating of the first session data is further based on the at least one environment attribute.

17. The system of claim 11, wherein the processing device is further configured for initiating the first session of the one or more sessions based on the request, wherein the generating of the first session data of the first session is further based on the initiating.

18. The system of claim 17, wherein the processing device is further configured for:
analyzing the at least one first action data, the at least one first user action data, and the first session data;
determining a learning status of the user corresponding to the first session; and
terminating the first session based on the learning status.

19. The system of claim 18, wherein the processing device is further configured for:
identifying a second session from the one or more sessions for the user to learn the training of the pets with a second behavior of the one or more pet behaviors based on the terminating of the first session and the learning status; and
generating a second session data of the second session based on the identifying of the second session and the training data, wherein the second session data comprises a second virtual representation of at least one of the pet, the at least one object, and the assistant, wherein the second session data further comprises at least one second action data associated with a second action and a second action instance of the second action of the second virtual representation, wherein the communication device is further configured for:
transmitting the second session data to the user device, wherein the extended reality device is further configured for rendering the second virtual representation and the second action of the second virtual representation at the second action instance; and
receiving at least one second user action data associated with a second user action and a second user action instance of the user from the user device, wherein the second user action at the second user action instance corresponds to the second action at the second action instance, wherein the extended reality device is further configured for rendering a second interaction between the user and the second virtual representation based on the at least one second user action data and the at least one second action data.

20. The system of claim 11 wherein the first action comprises a pet action associated with the pet, an object action associated with the at least one object, and an assistant action associated with the assistant, wherein the first action instance comprises a pet action instance associated with the pet action, an object action instance associated with the object instance, and an assistant action instance associated with the assistant action, wherein the assistant action at the assistant action instance prompts the first user action at the first user action instance, wherein the first user action at the first user action instance corresponds to at least one of the pet action at the pet action instance and the object action at the object action instance, wherein the extended reality device is further configured for rendering at least one prompt for the user based on the assistant action at the assistant action instance, wherein the user device further comprises at least one input device configured for capturing the first user action at the first user action instance for the at least one prompt for generating the at least one first user action data.
